(19) United States
(12) Patent Application Publication
(10) Pub. No.: US 2017/0134422 A1
(43) Pub. Date: May 11, 2017

(54) Deception Techniques Using Policy

(71) Applicant: vArmour Networks, Inc., Mountain View, CA (US)

(72) Inventors: Choung-Yaw Shieh, Palo Alto, CA (US); Cheng-Lin Hou, San Jose, CA (US); Zhiping Liu, Saratoga, CA (US)

(21) Appl. No.: 15/413,417

(22) Filed: Jan. 24, 2017

Related U.S. Application Data
(63) Continuation-in-part of application No. 14/480,318, filed on Sep. 8, 2014.
Application No. 14/480,318 is a continuation-in-part of application No. 15/299,433, filed on Oct. 20, 2016.
Application No. 15/299,433 is a continuation-in-part of application No. 15/201,351, filed on Jul. 1, 2016.
Application No. 15/201,351 is a continuation-in-part of application No. 15/192,967, filed on Jun. 24, 2016, now Pat. No. 9,560,081.
Application No. 15/192,967 is a continuation-in-part of application No. 15/394,640, filed on Dec. 29, 2016.
(60) Provisional application No. 61/965,981, filed on Feb. 11, 2014.

(51) Int. Cl. H04L 29/06

(52) U.S. Cl. CPC H04L 63/1491; H04L 63/1425; H04L 63/029

(57) ABSTRACT

Methods and systems for diversifying coverage of a deception point are provided. Exemplary methods include: receiving, by a first enforcement point in a first data network segment, a first data packet addressed to a first workload in the first data network segment; forwarding the first data packet to the deception point using a first low-level security rule set, the deception point logging the first data packet to produce a first log, receiving, by a second enforcement point in a second data network segment, a second data packet addressed to a second workload in the second data network segment, forwarding the second data packet to the deception point using a second low-level security rule set, the deception point logging the second data packet to produce a second log, the deception point providing the first and second logs to a security director for analysis.

### CROSS-REFERENCE TO RELATED APPLICATIONS

This application is a continuation-in-part of U.S. patent application Ser. No. 14/480,318, filed Sep. 8, 2014, which claims priority to U.S. Provisional Application No. 61/965,981, filed Feb. 11, 2014, the disclosures of which are hereby incorporated by reference for all purposes. This application is also a continuation-in-part of U.S. patent application Ser. No. 15/299,433, filed Oct. 20, 2016, which is a continuation-in-part of U.S. patent application Ser. No. 15/201,351, filed Jul. 1, 2016, which is a continuation-in-part of U.S. patent application Ser. No. 15/192,967, filed Jun. 24, 2016, the disclosures of which are hereby incorporated by reference for all purposes. This application is also a continuation-in-part of U.S. patent application Ser. No. 15/394,640, filed Dec. 29, 2016, the disclosure of which is hereby incorporated by reference for all purposes.

### FIELD OF THE INVENTION

The present technology pertains to computer security, and more specifically to computer network security.

### BACKGROUND ART

A hardware firewall is a network security system that controls incoming and outgoing network traffic. A hardware firewall generally creates a barrier between an internal network (assumed to be trusted and secure) and another network (e.g., the Internet) that is assumed not to be trusted and secure.

Attackers breach internal networks to steal critical data. For example, attackers target low-profile assets to enter the internal network. Inside the internal network and behind the hardware firewall, attackers move laterally across the internal network, exploiting East-West traffic flows, to critical enterprise assets. Once there, attackers siphon off valuable company and customer data.

### SUMMARY OF THE INVENTION

Some embodiments of the present technology include computer-implemented methods for diversifying coverage of a deception point, which may include: receiving, by a first enforcement point in a first data network segment, a first data packet addressed to a first workload in the first data network segment; and forwarding the first data packet to the deception point using a first low-level security rule set, the deception point being different from the first workload, the deception point logging the first data packet to produce a first log, the first low-level security rule set being produced using a high-level declarative security policy, the high-level declarative security policy including a high-level security statement. Some embodiments may further include: receiving, by a second enforcement point in a second data network segment, a second data packet addressed to a second workload in the second data network segment, the first data network segment and the second data network segment being in a common network; and forwarding the second data packet to the deception point using a second low-level security rule set, the deception point being different from the second workload, the deception point logging the second data packet to produce a second log, the deception point providing the first and second logs to a security director for analysis, the second low-level security rule set being produced using the high-level declarative security policy including the high-level security statement.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments. The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a simplified block diagram of an (physical) environment, according to some embodiments.

FIG. 2 is simplified block diagram of an (virtual) environment, in accordance with various embodiments.

FIG. 3 is simplified block diagram of an environment, according to various embodiments.

FIG. 4 is a simplified block diagram of an environment, in accordance with some embodiments.

FIG. 5A illustrates example metadata, according to various embodiments.

FIG. 5B is a table of example expected behaviors in accordance with some embodiments.

FIG. 5C depicts an example workload model in accordance with various embodiments.

FIG. 6 is a simplified flow diagram of a method, according to various embodiments.

FIG. 7A is a simplified block diagram of a system, in accordance with some embodiments.

FIG. 7B is a simplified block diagram of the system of FIG. 7A depicting additional and/or alternative elements, in accordance with various embodiments.

FIG. 7C is a simplified block diagram of the system of FIG. 7B depicting additional and/or alternative elements, in accordance with various embodiments.

FIG. 8 is a simplified flow diagram, according to some embodiments.

FIG. 9 is a simplified block diagram of a computing system, according to various embodiments.

FIG. 10 is a simplified block diagram of the systems of FIGS. 7A-7C depicting additional and/or alternative elements, in accordance with some embodiments.

FIG. 11 is a simplified flow diagram, in accordance with various embodiments.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Information technology (IT) organizations face cyber threats and advanced attacks. Firewalls are an important part of network security. Firewalls control incoming and outgoing network traffic using a rule set. A rule, for example, allows a connection to a specific (Internet Protocol (IP)) address (and/or port), allows a connection to a specific (IP) address (and/or port) if the connection is secured (e.g., using Internet Protocol security (IPsec)), blocks a connection to a specific (IP) address (and/or port), redirects a connection from one IP address (and/or port) to another IP address (and/or port), logs communications to and/or from a specific IP address (and/or port), and the like. A firewall rule at a low level of abstraction may indicate a specific (IP) address and protocol to which connections are allowed and/or not allowed.

Managing a set of firewall rules is a difficult challenge. Some IT security organizations have a large staff (e.g., dozens of staff members) dedicated to maintaining firewall policy (e.g., a firewall rule set). A firewall rule set can have tens of thousands or even hundreds of thousands of rules. Some embodiments of the present technology may autonomically generate a reliable declarative security policy at a high level of abstraction. Abstraction is a technique for managing complexity by establishing a level of complexity which suppresses the more complex details below the current level. The high-level declarative policy may be compiled to produce a firewall rule set at a low level of abstraction.

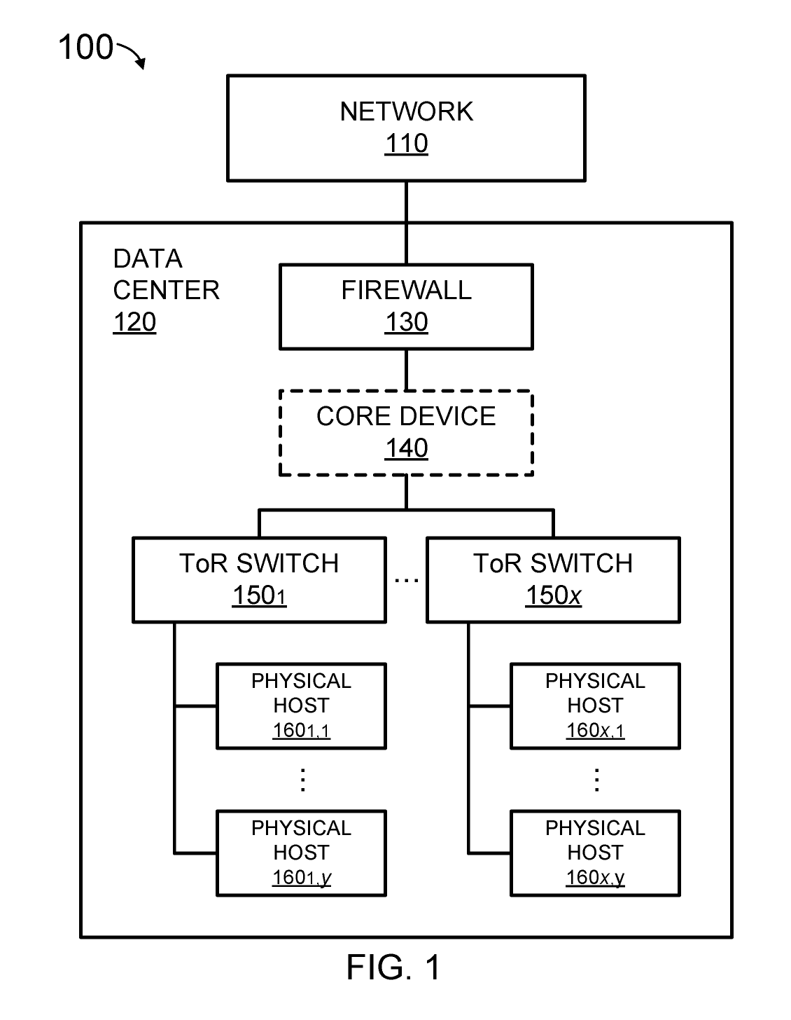

FIG. 1 illustrates a system 100 according to some embodiments. System 100 includes network 110 and data center 120. In various embodiments, data center 120 includes firewall 130, optional core switch/router (also referred to as a core device) 140, Top of Rack (ToR) switches 150₁-150ₓ, and physical hosts 160_{1,1}-160_{x,y}.

Network 110 (also referred to as a computer network or data network) is a telecommunications network that allows computers to exchange data. For example, in network 110, networked computing devices pass data to each other along data connections (e.g., network links). Data can be transferred in the form of packets. The connections between nodes may be established using either cable media or wireless media. For example, network 110 includes at least one of a local area network (LAN), wireless local area network (WLAN), wide area network (WAN), metropolitan area network (MAN), and the like. In some embodiments, network 110 includes the Internet.

Data center 120 is a facility used to house computer systems and associated components. Data center 120, for example, comprises computing resources for cloud computing services or operated for the benefit of a particular organization. Data center equipment, for example, is generally mounted in rack cabinets, which are usually placed in single rows forming corridors (e.g., aisles) between them. Firewall 130 creates a barrier between data center 120 and network 110 by controlling incoming and outgoing network traffic based on a rule set.

Optional core switch/router 140 is a high-capacity switch/router that serves as a gateway to network 110 and provides communications between ToR switches 150₁ and 150ₓ, and between ToR switches 150₁ and 150ₓ and network 110. ToR switches 150₁ and 150ₓ connect physical hosts 160_{1,1}-160_{1,y} and 160_{x,1}-160_{x,y} (respectively) together and to network 110 (optionally through core switch/router 140). For example, ToR switches 150₁-150ₓ use a form of packet switching to forward data to a destination physical host (of physical hosts 160_{1,1}-160_{x,y}) and (only) transmit a received message to the physical host for which the message was intended.

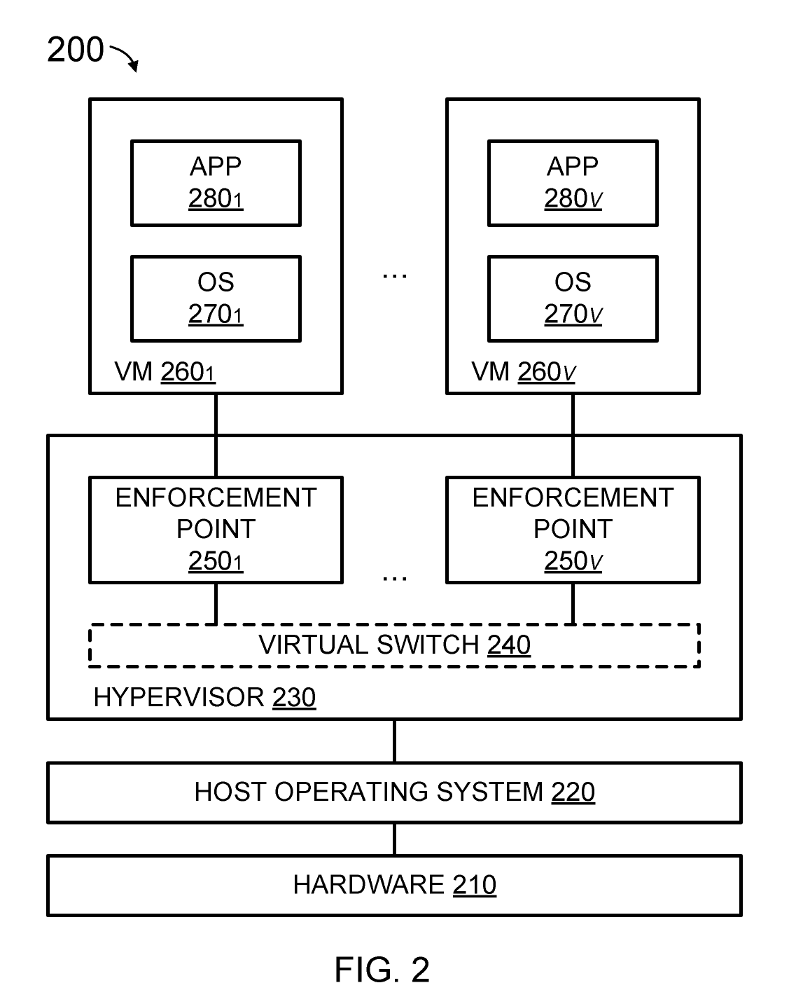

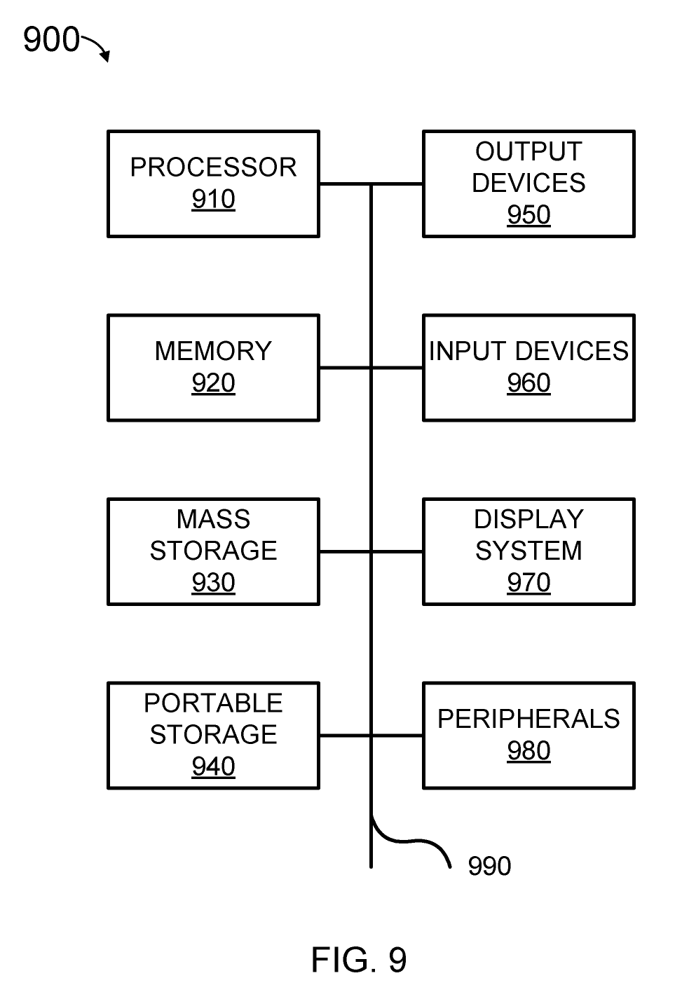

In some embodiments, physical hosts 160_{1,1}-160_{x,y} are computing devices that act as computing servers such as blade servers. Computing devices are described further in relation to FIG. 9. For example, physical hosts 160_{1,1}-160_{x,y} comprise physical servers performing the operations described herein, which can be referred to as a bare-metal server environment. Additionally or alternatively, physical hosts 160_{1,1}-160_{x,y} may be a part of a cloud computing environment. Cloud computing environments are described further in relation to FIG. 9. By way of further non-limiting example, physical hosts 160_{1,1}-160_{x,y} can host different combinations and permutations of virtual and container environments (which can be referred to as a virtualization environment), which are described further below in relation to FIGS. 2-4.

FIG. 2 depicts (virtual) environment 200 according to various embodiments. In some embodiments, environment 200 is implemented in at least one of physical hosts 160_{1,1}-160_{x,y} (FIG. 1). Environment 200 includes hardware 210, host operating system (OS) 220, hypervisor 230, and virtual machines (VMs) 260₁-260_{V}. In some embodiments, hardware 210 is implemented in at least one of physical hosts 160_{1,1}-160_{x,y} (FIG. 1). Host operating system 220 can run on hardware 210 and can also be referred to as the host kernel. Hypervisor 230 optionally includes virtual switch 240 and includes enforcement points 250₁-250_{V}. VMs 260₁-260_{V} each include a respective one of operating systems (OSes) 270₁-270_{V} and applications (APPs) 280₁-280_{V}.

Hypervisor (also known as a virtual machine monitor (VMM)) 230 is software running on at least one of physical hosts 160_{1,1}-160_{x,y}, and hypervisor 230 runs VMs 260₁-260_{V}. A physical host (of physical hosts 160_{1,1}-160_{x,y}) on which hypervisor 230 is running one or more virtual machines 260₁-260_{V}, is also referred to as a host machine. Each VM can also be referred to as a guest machine.

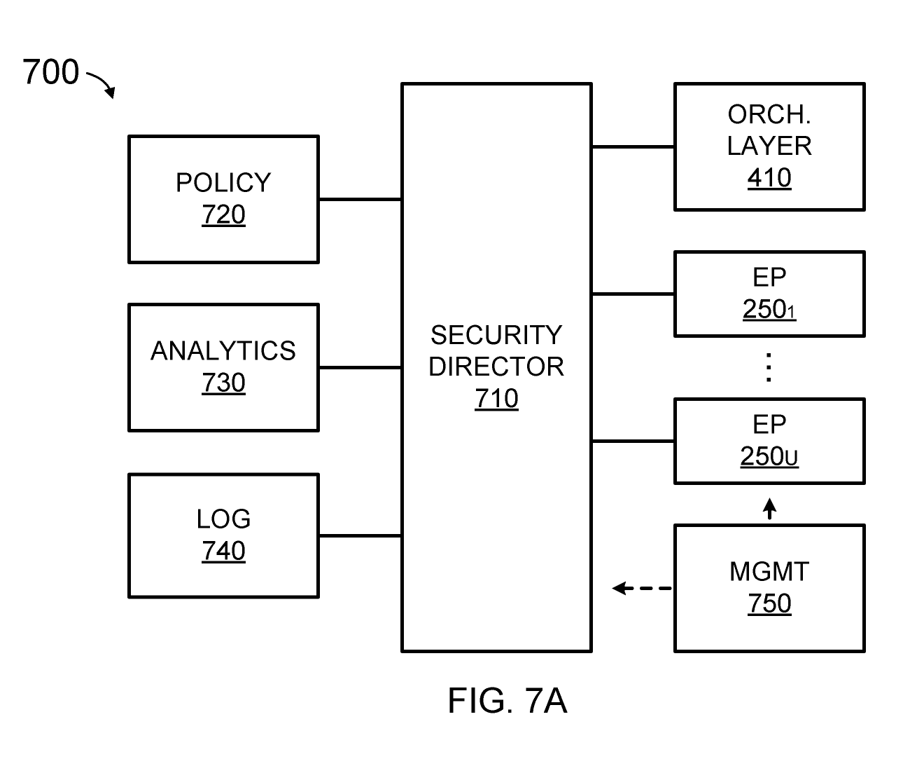

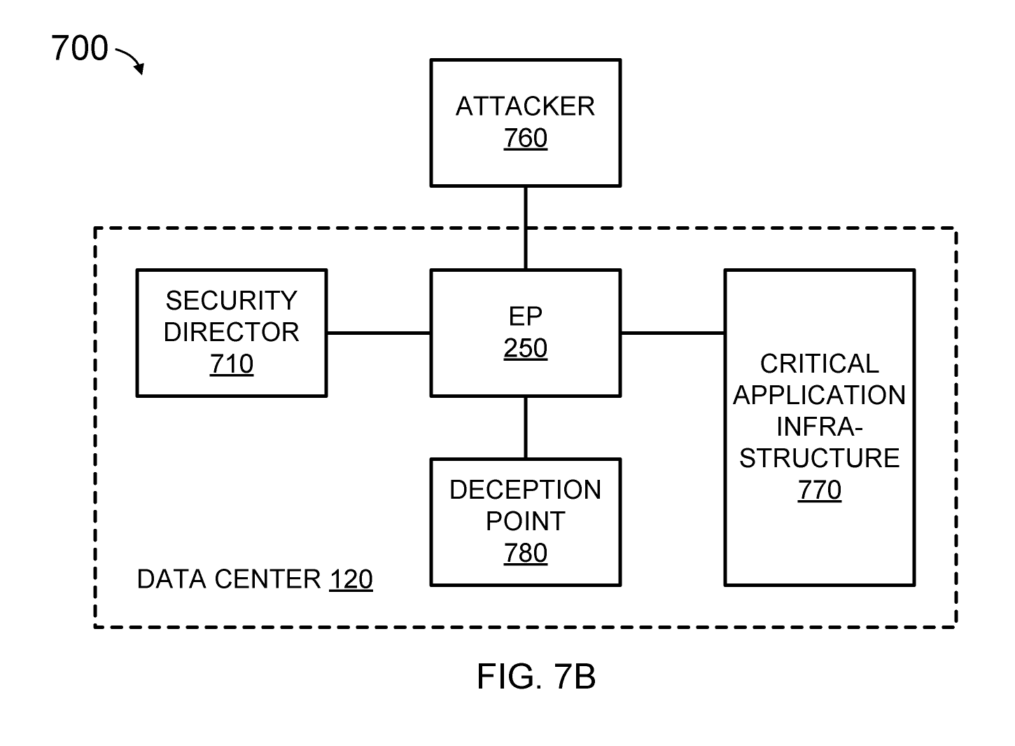

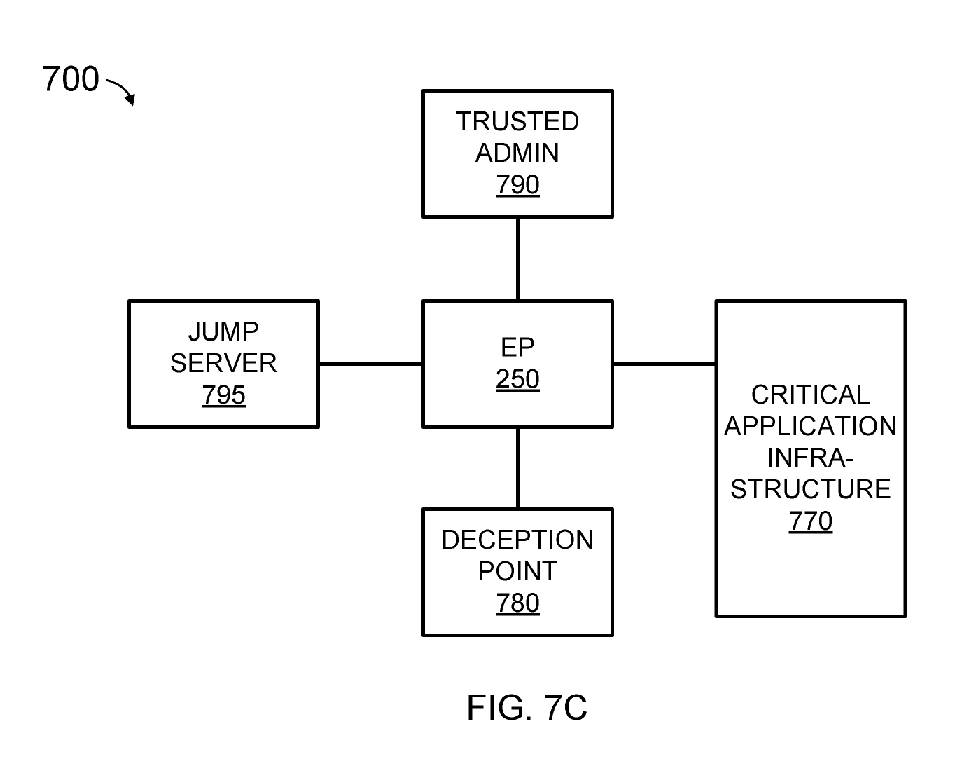

For example, hypervisor 230 allows multiple OSes 270₁-270_{V} to share a single physical host (of physical hosts 160_{1,1}-160_{x,y}). Each of OSes 270₁-270_{V} appears to have the host machine's processor, memory, and other resources all to itself. However, hypervisor 230 actually controls the host machine's processor and resources, allocating what is needed to each operating system in turn and making sure that the guest OSes (e.g., virtual machines 260₁-260_{V}) cannot disrupt each other. OSes 270₁-270_{V} are described further in relation to FIG. 7.

VMs 260₁-260_{V} also include applications 280₁-280_{V}. Applications (and/or services) 280₁-280_{V} are programs designed to carry out operations for a specific purpose. Applications 280₁-280_{V} can include at least one of web application (also known as web apps), web server, transaction processing, database, and the like software. Applications 280₁-280_{V} run using a respective OS of OSes 270₁-270_{V}.

Hypervisor 230 optionally includes virtual switch 240. Virtual switch 240 is a logical switching fabric for networking VMs 260₁-260_{V}. For example, virtual switch 240 is a program running on a physical host (of physical hosts 160_{1,1}-160_{x,y}) that allows a VM (of VMs 260₁-260_{V}) to communicate with another VM.

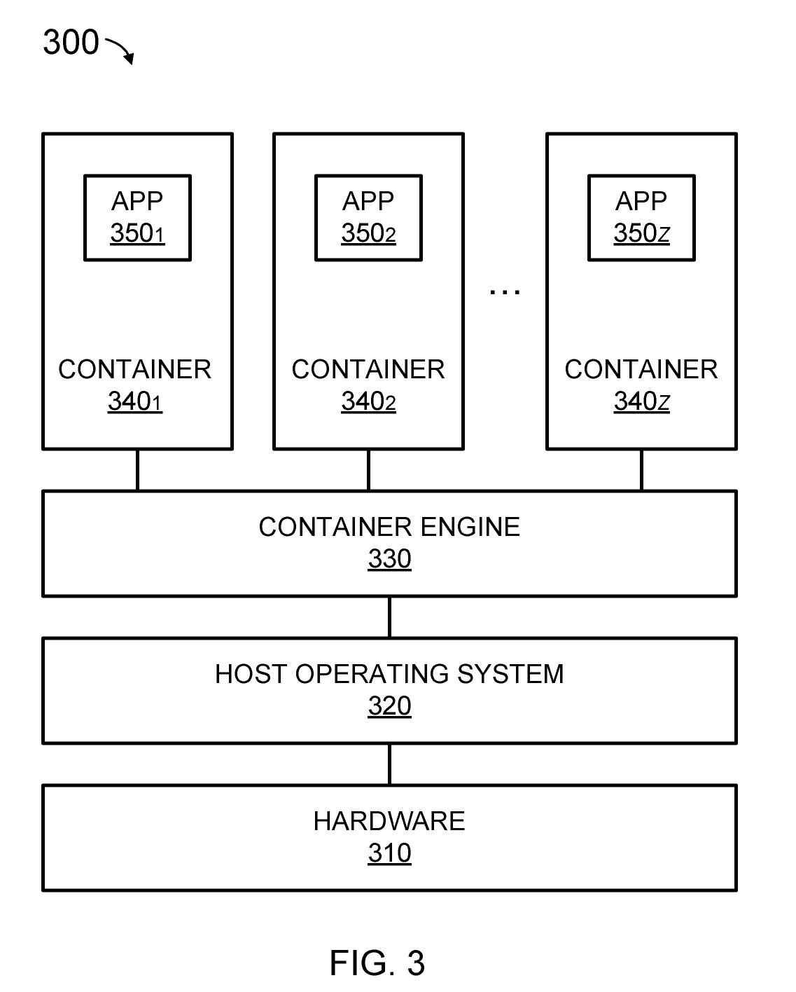

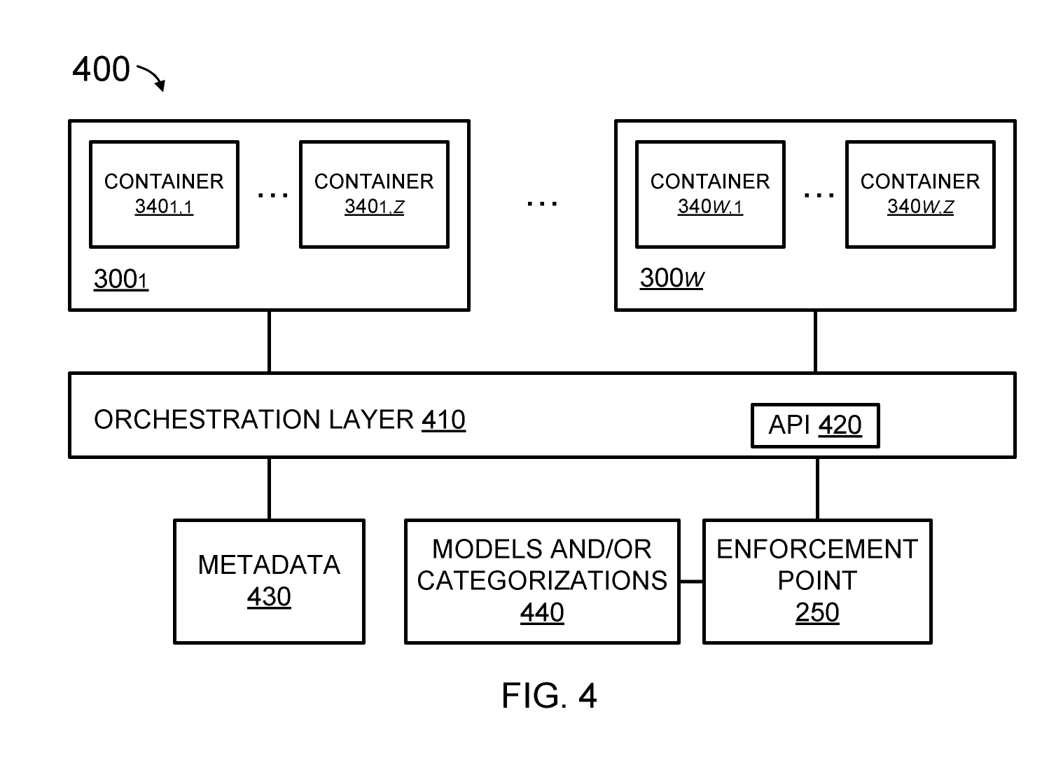

Hypervisor 230 also includes enforcement points 250₁-250_{V}, according to some embodiments. For example, enforcement points 250₁-250_{V} are a firewall service that provides network traffic filtering and monitoring for VMs 260₁-260_{V} and containers (described below in relation to FIGS. 3 and 4). Enforcement points 250₁-250_{V} are described further in related United States patent application “Methods and Systems for Orchestrating Physical and Virtual Switches to Enforce Security Boundaries” (application Ser. No. 14/677,827) filed Apr. 2, 2015, which is hereby incorporated by reference for all purposes. Although enforcement points 250₁-250_{V} are shown in hypervisor 230, enforcement points 250₁-250_{V} can additionally or alternatively be realized in one or more containers (described below in relation to FIGS. 3 and 4).

According to some embodiments, enforcement points 250₁-250_{V} control network traffic to and from a VM (of VMs 260₁-260_{V}) (and/or a container) using a rule set. A rule, for example, allows a connection to a specific (IP) address, allows a connection to a specific (IP) address if the connection is secured (e.g., using IPsec), denies a connection to a specific (IP) address, redirects a connection from one IP address to another IP address (e.g., to a deception point), logs communications to and/or from a specific IP address, and the like. Each address is virtual, physical, or both. Connections are incoming to the respective VM (or a container), outgoing from the respective VM (or container), or both. Redirection is described further in related United States patent application “System and Method for Threat-Driven Security Policy Controls” (application Ser. No. 14/673,679) filed Mar. 30, 2015, which is hereby incorporated by reference for all purposes.

In some embodiments, logging includes metadata associated with action taken by enforcement point 250 (of enforcement points 250₁-250_{V}), such as the permit, deny, and log behaviors. For example, for a Domain Name System (DNS) request, metadata associated with the DNS request, and the action taken (e.g., permit/forward, deny/block, redirect, and log behaviors) are logged. Activities associated with other (application-layer) protocols (e.g., Dynamic Host Configuration Protocol (DHCP), Domain Name System (DNS), File Transfer Protocol (FTP), Hypertext Transfer Protocol (HTTP), Internet Message Access Protocol (IMAP), Post Office Protocol (POP), Secure Shell (SSH), Secure Sockets Layer (SSL), Transport Layer Security (TLS), and the like) and their respective metadata may be additionally or alternatively logged. For example, metadata further includes at least one of a source (IP) address and/or hostname, a source port, destination (IP) address and/or hostname, a destination port, protocol, application, and the like.

FIG. 3 depicts environment 300 according to various embodiments. Environment 300 includes hardware 310, host operating system 320, container engine 330, and containers 340₁-340_{z}. In some embodiments, hardware 310 is implemented in at least one of physical hosts 160_{1,1}-160_{x,y} (FIG. 1). Host operating system 320 runs on hardware 310 and can also be referred to as the host kernel. By way of non-limiting example, host operating system 320 can be at least one of: Linux, Red Hat® Enterprise Linux® Atomic Enterprise Platform, CoreOS®, Ubuntu® Snappy, Pivotal Cloud Foundry®, Oracle® Solaris, and the like. Host operating system 320 allows for multiple (instead of just one) isolated user-space instances (e.g., containers 340₁-340_{z}) to run in host operating system 320 (e.g., a single operating system instance).

Host operating system 320 can include a container engine 330. Container engine 330 can create and manage containers 340₁-340₂, for example, using an (high-level) application programming interface (API). By way of non-limiting example, container engine 330 is at least one of Docker®, Rocket (rkt), Solaris Containers, and the like. For example, container engine 330 may create a container (e.g., one of containers 340₁-340_{z}) using an image. An image can be a (read-only) template comprising multiple layers and can be built from a base image (e.g., for host operating system 320) using instructions (e.g., run a command, add a file or directory, create an environment variable, indicate what process (e.g., application or service) to run, etc.). Each image may be identified or referred to by an image type. In some embodiments, images (e.g., different image types) are stored and delivered by a system (e.g., server side application) referred to as a registry or hub (not shown in FIG. 3).

Container engine 330 can allocate a filesystem of host operating system 320 to the container and add a read-write layer to the image. Container engine 330 can create a network interface that allows the container to communicate with hardware 310 (e.g., talk to a local host). Container engine 330 can set up an Internet Protocol (IP) address for the container (e.g., find and attach an available IP address from a pool). Container engine 330 can launch a process (e.g., application or service) specified by the image (e.g., run an application, such as one of APP 350₁-350_{z}, described further below). Container engine 330 can capture and provide application output for the container (e.g., connect and log standard input, outputs and errors). The above examples are only for illustrative purposes and are not intended to be limiting.

Containers 340₁-340_{z} can be created by container engine 330. In some embodiments, containers 340₁-340_{z}, are each an environment as close as possible to an installation of host operating system 320, but without the need for a separate kernel. For example, containers 340₁-340_{z} share the same operating system kernel with each other and with host operating system 320. Each container of containers 340₁-340z can run as an isolated process in user space on host operating system 320. Shared parts of host operating system 320 can be read only, while each container of containers 340₁-340_{z} can have its own mount for writing.

Containers 340₁-340_{z} can include one or more applications (APP) 350₁-350_{z} (and all of their respective dependencies). APP 350₁-350_{z} can be any application or service. By way of non-limiting example, APP 350₁-350_{z} can be a database (e.g., Microsoft® SQL Server®, MongoDB, HTFS, MySQL®, Oracle® database, etc.), email server (e.g., Sendmail®, Postfix, qmail, Microsoft® Exchange Server, etc.), message queue (e.g., Apache® Qpid™, RabbitMQ®, etc.), web server (e.g., Apache® HTTP Server™, Microsoft® Internet Information Services (IIS), Nginx, etc.), Session Initiation Protocol (SIP) server (e.g., Kamailio® SIP Server, Avaya® Aura® Application Server 5300, etc.), other media server (e.g., video and/or audio streaming, live broadcast, etc.), file server (e.g., Linux server, Microsoft® Windows Server®, Network File System (NFS), HTTP File Server (HFS), Apache® Hadoop®, etc.), service-oriented architecture (SOA) and/or microservices process, object-based storage (e.g., Lustre®, EMC® Centera®, Scality® RING®, etc.), directory service (e.g., Microsoft® Active Directory®, Domain Name System (DNS) hosting service, etc.), monitoring service (e.g., Zabbix®, Qualys®, HP® Business Technology Optimization (BTO; formerly OpenView), etc.), logging service (e.g., syslog-ng, Splunk®, etc.), and the like.

Each of VMs 260₁-260_{V} (FIG. 2) and containers 340₁-340_{z} can be referred to as workloads and/or endpoints. In contrast to hypervisor-based virtualization VMs 260₁-260_{V}, containers 340₁-340_{z} may be an abstraction performed at the operating system (OS) level, whereas VMs are an abstraction of physical hardware. Since VMs 260₁-260_{V} can virtualize hardware, each VM instantiation of VMs 260₁-260_{V} can have a full server hardware stack from virtualized Basic Input/Output System (BIOS) to virtualized network adapters, storage, and central processing unit (CPU). The entire hardware stack means that each VM of VMs 260₁-260_{V} needs its own complete OS instantiation and each VM must boot the full OS.

FIG. 4 illustrates environment 400, according to some embodiments. Environment 400 can include one or more of enforcement point 250, environments 300₁-300_{W}, orchestration layer 410, metadata 430, and models (and/or categorizations) 440. Enforcement point 250 can be an enforcement point as described in relation to enforcement points 250₁-250_{V} (FIG. 2). Environments 300₁-300_{W} can be instances of environment 300 (FIG. 3), include containers 340_{1,1}-340_{W,Z}, and be in at least one of data center 120 (FIG. 1). Containers 340_{1,1}-340_{W,Z} (e.g., in a respective environment of environments 300₁-300_{W}) can be a container as described in relation to containers 340₁-340_{Z} (FIG. 3).

Orchestration layer 410 can manage and deploy containers 340_{1,1}-340_{W,Z} across one or more environments 300₁-300_{W} in one or more data centers of data center 120 (FIG. 1). In some embodiments, to manage and deploy containers 340_{1,1}-340_{W,Z}, orchestration layer 410 receives one or more image types (e.g., named images) from a data storage and content delivery system referred to as a registry or hub (not shown in FIG. 4). By way of non-limiting example, the registry can be the Google Container Registry. In various embodiments, orchestration layer 410 determines which environment of environments 300₁-300_{W} should receive each container of containers 340_{1,1}-340_{W,Z} (e.g., based on the environments' 300₁-300_{W} current workload and a given redundancy target). Orchestration layer 410 can provide means of discovery and communication between containers 340_{1,1}-340_{W,Z}. According to some embodiments, orchestration layer 410 runs virtually (e.g., in one or more containers 340_{1,1}-340_{W,Z} orchestrated by a different one of orchestration layer 410 and/or in one or more of hypervisor 230 (FIG. 2)) and/or physically (e.g., in one or more physical hosts of physical hosts 160_{1,1}-160_{x,y} (FIG. 1) in one or more of data center 120. By way of non-limiting example, orchestration layer 410 is at least one of Docker Swarm®, Kubernetes®, Cloud Foundry® Diego, Apache® Mesos™, and the like.

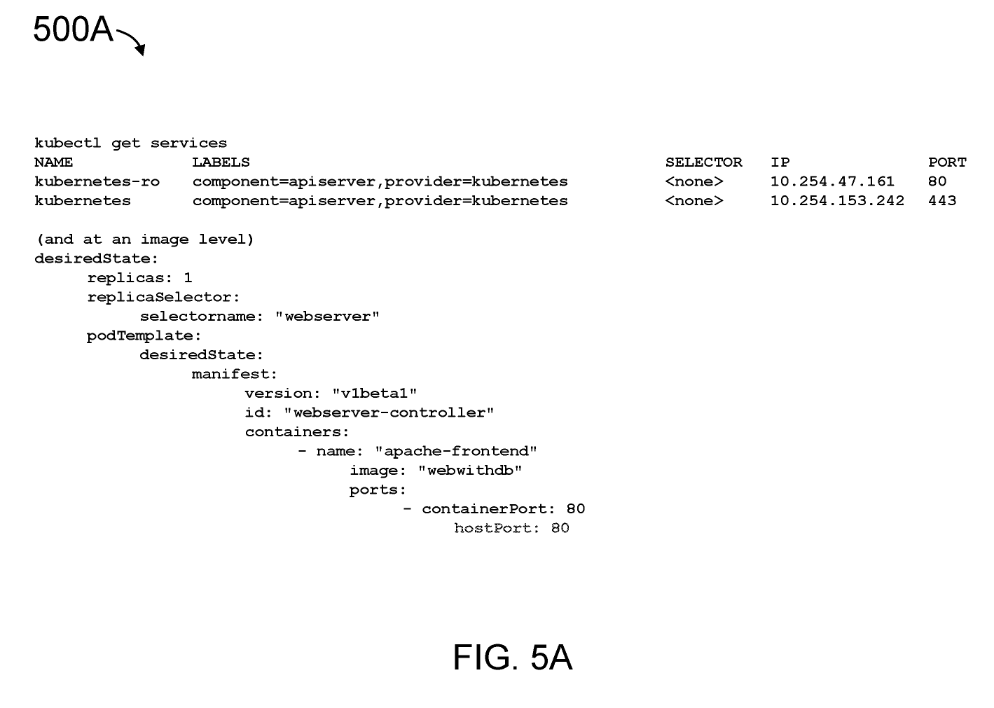

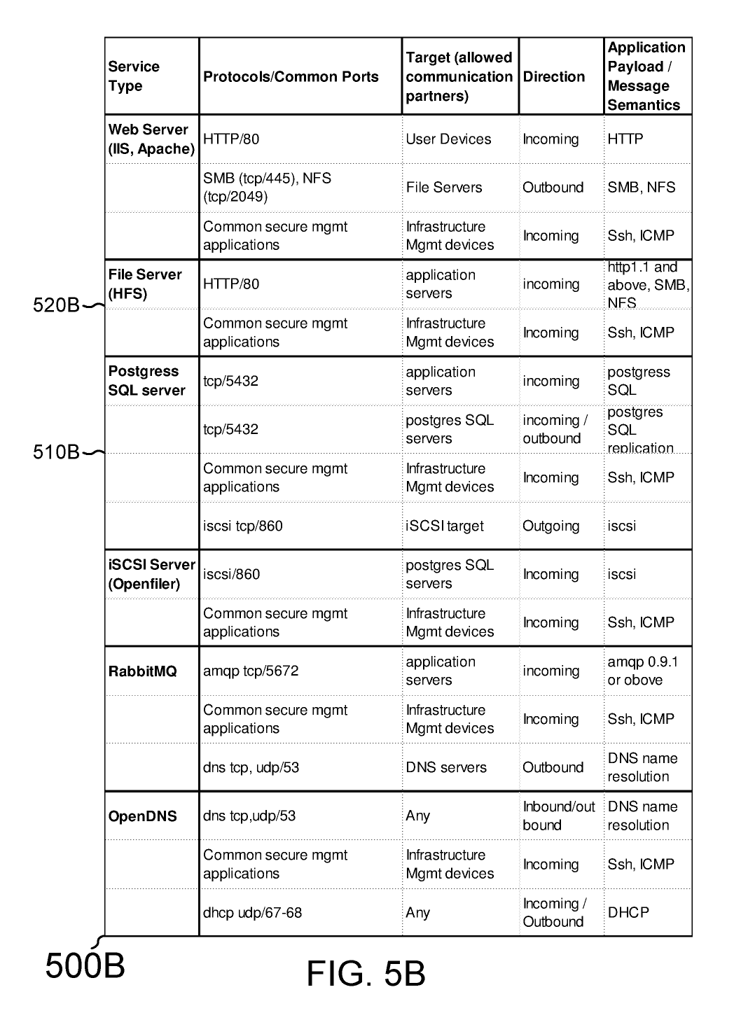

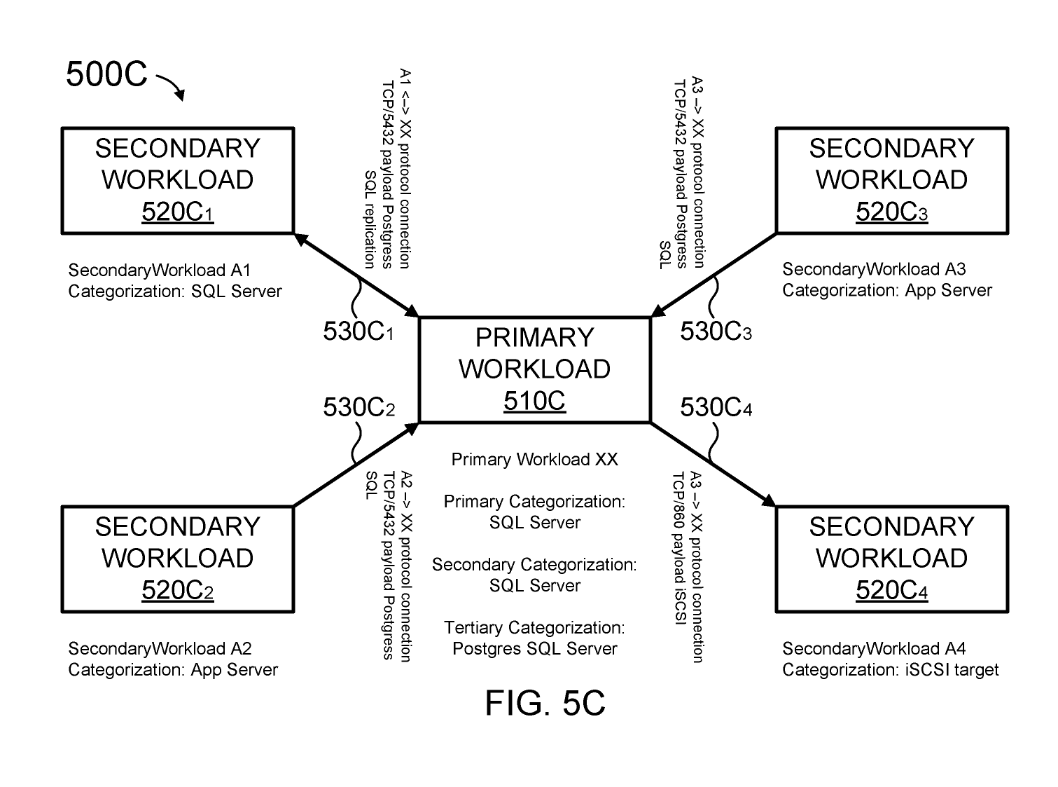

Orchestration layer 410 can maintain (e.g., create and update) metadata 430. Metadata 430 can include reliable and authoritative metadata concerning containers (e.g., containers 340_{1,1}-340_{W,Z}). FIG. 5A illustrates metadata example 500A, a non-limiting example of metadata 430 (FIG. 4). By way of illustration, metadata example 500A indicates for a container at least one of: an image name (e.g., file name including at least one of a network device (such as a host, node, or server) that contains the file, hardware device or drive, directory tree (such as a directory or path), base name of the file, type (such as format or extension) indicating the content type of the file, and version (such as revision or generation number of the file), an image type (e.g., including name of an application or service running), the machine with which the container is communicating (e.g., IP address, hostname, etc.), and a respective port through which the container is communicating, and other tag and/or label (e.g., a (user-configurable) tag or label such as a Kubernetes® tag, Docker® label, etc.), and the like. In various embodiments, metadata 430 is generated by orchestration layer 410—which manages and deploys containers—and can be very timely (e.g., metadata is available soon after an associated container is created) and highly reliable (e.g., accurate). In addition or alternative to metadata example 500A, other metadata may comprise metadata 430 (FIG. 4). For example, other elements (e.g., service name, (user-configurable)tag and/or label, and the like) associated with models 440 are used. By way of further non-limiting example, metadata 430 includes an application determination using application identification (AppID). AppID can process data packets at a byte level and can employ signature analysis, protocol analysis, heuristics, and/or behavioral analysis to identify an application and/or service. In some embodiments, AppID inspects only a part of a data payload (e.g., only parts of some of the data packets). By way of non-limiting example, AppID is at least one of Cisco® OpenAppID, Qosmos ixEngine®, Palo Alto Networks® APP-ID™, and the like.

Referring back to FIG. 4, enforcement point 250 can receive metadata 430, for example, through application programming interface (API) 420. Other interfaces can be used to receive metadata 430. In some embodiments, enforcement point 250 can include models 440. Models 440 can include a model(s) of expected (network communications) behavior(s) for an image type(s). For example, expected (network communications) behaviors can include at least one of: protocols and/or ports that should be used by a container and who the container should talk to (e.g., relationships between containers, such as other applications and/or services the container should talk to), and the like. In some embodiments, models 440 include a model of expected (network communications) behavior for applications and/or services running in a VM (e.g., of VMs 260₁-260_{V} shown in FIG. 2). A model of expected behavior for an image type is described further below in relation to FIG. 5B.

Models 440 may additionally or alternatively include a model(s) for a workload(s) (or workload model). A workload model can describe behavior and relationships of a particular workload (referred to as the primary workload) with other workloads (referred to as secondary workloads). A workload model is described further below in relation to FIG. 5C.

In various embodiments, models 440 are modifiable by an operator, such that a security policy is adapted to the evolving security challenges confronting the IT organization. For example, the operator provides permitted and/or forbidden (network communications) behaviors via at least one of a graphical user interface (GUI), command-line interface (CLI), application programming interface (API), and the like (not depicted in FIG. 4).

FIG. 5B shows table 500B representing non-limiting examples of expected behaviors which can be included in models 440 (FIG. 4), according to some embodiments. For example, database server 510B can be expected to communicate using transmission control protocol (TCP), common secure management applications, and Internet Small Computer System (iSCSI) TCP. By way of further non-limiting example, database server 510B can be expected to communicate with application servers, other database servers, infrastructure management devices, and iSCSI target. In some embodiments, if database server 510B were to communicate with a user device using Hypertext Transfer Protocol (HTTP), then such a deviation from expected behavior could be used at least in part to detect a security breach.

By way of additional non-limiting example, file server 520B (e.g., HTTP File Server or HFS) can be expected to communicate using HTTP and common secure management applications. For example, file server 520B can be expected to communicate with application servers and infrastructure management devices. In various embodiments, if file server 520B were to communicate with a user device using Hypertext Transfer Protocol (HTTP), then such a deviation from expected behavior could be used at least in part to detect a security breach.

Many other deviations from expected behavior are possible. Additionally, other different combinations and/or permutations of services, protocols (e.g., Advanced Message Queuing Protocol (AMQP), DNS, Dynamic Host Configuration Protocol (DHCP), Network File System (NFS), Server Message Block (SMB), User Datagram Protocol (UDP), and the like) and common ports, communication partners, direction, and application payload and/or message semantics (e.g., Secure Shell (SSH), Internet Control Message Protocol (ICMP), Structured Query Language (SQL), and the like), including ones not depicted in FIG. 5B may be used. Enforcement point 250 can be realized in at least one of a virtual and container environment.

In some embodiments, using metadata 430 and models of expected behavior (e.g., included in models 440), enforcement point 250 applies heuristics to generate a high-level declarative security policy associated with a container (e.g., of containers 340_{1,1}-340_{W,Z}). A high-level security policy can comprise one or more high-level security statements, where there is one high-level security statement per allowed protocol, port, and/or relationship combination. In some embodiments, enforcement point 250 determines an image type using metadata 430 and matches the image type with one or more models of expected behavior (e.g., included in models 440) associated with the image type. For example, if/when the image type corresponds to a certain database application, then one or more models associated with that database are determined. A list of at least one of: allowed protocols, ports, and relationships for the database may be determined using the matched model(s).

In various embodiments, enforcement point 250 produces a high-level declarative security policy for the container using the list of at least one of: allowed protocols, ports, and relationships. The high-level declarative security policy can be at least one of: a statement of protocols and/or ports the container is allowed to use, indicate applications/services that the container is allowed to communicate with, and indicate a direction (e.g., incoming and/or outgoing) of permitted communications. According to some embodiments, single application/service is subsequently used to identify several different machines associated with the single application/service. The high-level declarative security policy is at a high level of abstraction, in contrast with low-level firewall rules, which are at a low level of abstraction and only identify specific machines by IP address and/or hostname. Accordingly, one high-level declarative security statement can be compiled to produce hundreds or more of low-level firewall rules.

The high-level security policy can be compiled by enforcement point 250 (or other machine) to produce a low-level firewall rule set. Compilation is described further in related United States patent application “Conditional Declarative Policies” (application Ser. No. 14/673,640) filed Mar. 30, 2015, which is hereby incorporated by reference for all purposes.

According to some embodiments, a low-level firewall rule set is used by enforcement point 250 to determine when the high-level security policy is (possibly) violated. For example, a database (e.g., in a container of containers 340_{1,1}-340_{W,Z}) serving web pages using the Hypertext Transfer Protocol (HTTP) and/or communicating with external networks (e.g., network 110 of FIG. 1) could violate a high-level declarative security policy for that database container. In various embodiments, enforcement point 250 is an enforcement point (e.g., in a container of containers 340_{1,1}-340_{W,Z}). Enforcement points are described further in related United States patent application “Methods and Systems for Orchestrating Physical and Virtual Switches to Enforce Security Boundaries” (application Ser. No. 14/677,827) filed Apr. 2, 2015, which is hereby incorporated by reference for all purposes. Detection of a (potential) violation of the high-level security policy and violation handling are described further in related United States patent application “System and Method for Threat-Driven Security Policy Controls” (application Ser. No. 14/673,679) filed Mar. 30, 2015, which is hereby incorporated by reference for all purposes. For example, when a (potential) violation of the high-level security policy is detected, enforcement point 250 (or other machine) issues an alert and/or drops/forwards network traffic that violates the high-level declarative security policy.

FIG. 5C shows a model for a workload (or workload model) 500C which can be included in models 440 (FIG. 4), according to some embodiments. Workload model 500C can describe behavior and relationships of primary workload 510C with other workloads (e.g., secondary workloads 520C₁-520C₄). By way of non-limiting example, primary workload 510C has a primary categorization of SQL Server, secondary categorization of SQL server, and tertiary categorization of Postgres SQL Server. Primary workload 510C communicates with secondary workload 520C₁ through (protocol) connection 530C₁, with secondary workload 520C₂ through (protocol) connection 530C₂, with secondary workload 520C₃ through (protocol) connection 530C₃, and with secondary workload 520C₄ through (protocol) connection 530C₄. By way of further non-limiting example, secondary workload 520C₁ has a categorization of SQL server and connection 530C₁ uses TCP/5432 payload Postgres SQL replication, secondary workload 520C₂ has a categorization of App Server and connection 530C₂ uses TCP/5432 payload Postgres SQL, secondary workload 520C₃ has a categorization of App server and connection 530C₃ uses TCP/5432 payload Postgres SQL, and secondary workload 520C₄ has a categorization of iSCSI target and connection 530C₄ uses TCP/860 payload iSCSI.

Workload model 500C for primary workload 510C can be checked for sustained convergence with expected behavior(s). By way of non-limiting example, does primary workload 510C conform to the expected behavior (e.g., 510B in FIG. 5B) for a Postgres SQL server service type? Are the protocol connections maintained by primary workload 510C in workload model 500C consistent with expected behavior for a Postgres SQL service type (e.g., at least one of protocols and/or common ports, communications direction, and application payload/message semantics)? Are the categorizations of secondary workloads 520C₁-520C₄ consistent with at least one of expected communications targets (or allowed communication partners)? Optionally, does the metadata (e.g., metadata 430 received from orchestration layer 410 in FIG. 4) consistent with workload model 500C (e.g., at least one of primary categorization (service type), protocols and/or common ports, communications targer (allowed communication partners), communications direction, and application payload/message semantics? In some embodiments, workload model 500C having sustained convergence can be used to build a high-level security policy.

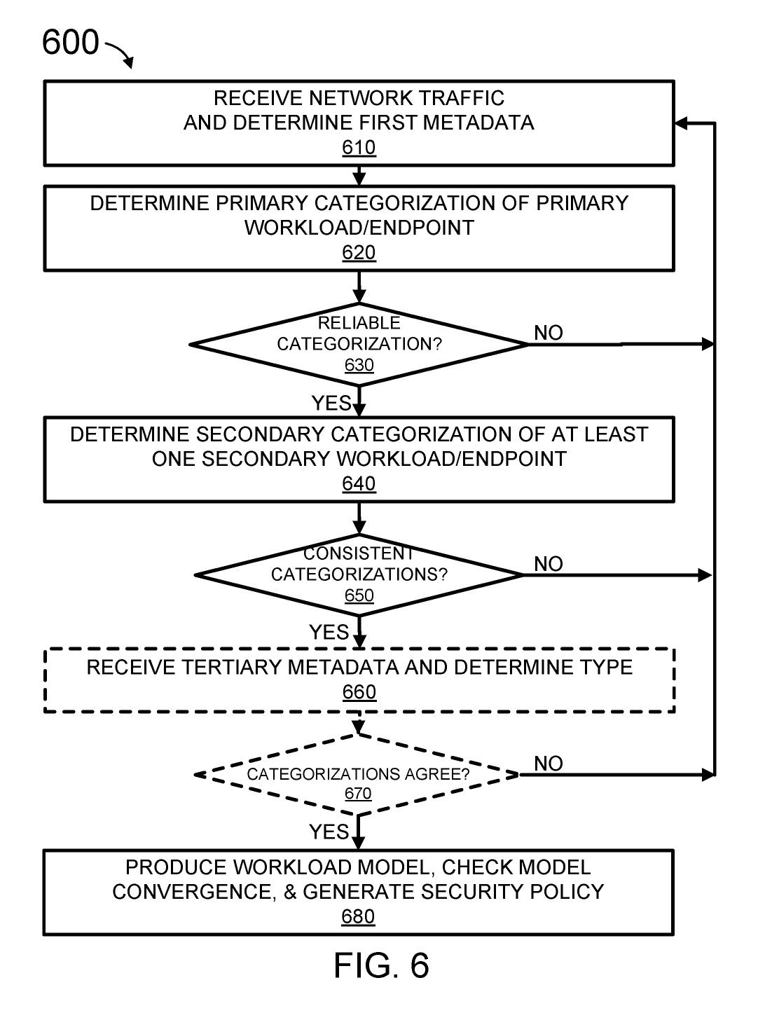

FIG. 6 illustrates a method (or process) 600 for generating a high-level declarative security policy (or statement), according to some embodiments. In various embodiments, method 600 is performed by enforcement point 250 (FIG. 4). At step 610, network traffic/communications between a primary VM (of VMs 260₁-260_{V} shown in FIG. 2) or container (of containers 340_{1,1}-340_{W,Z} shown in FIG. 4) and at least one secondary VM (of VMs 260₁-260_{V}) or container (of containers 340_{1,1}-340_{W,Z}) may be received, where the primary VM or container can be different from the secondary VM or container. For example, enforcement point 250 receives network communications originating from or arriving for the primary VM or container, the network communications arriving for or originating from (respectively) the secondary VM or container.

Additionally or alternatively at step 610, enforcement point 250 can determine first metadata associated with the network traffic. For example, the first metadata can be at least one of a source (IP) address and/or hostname, a source port, destination (IP) address and/or hostname, a destination port, protocol, application, and the like associated with each of the received network communications.

At step 620, a primary categorization—e.g., associated with the primary VM (of VMs 260₁-260_{V} shown in FIG. 2) or container (of containers 340_{1,1}-340_{W,Z} shown in FIG. 4)—may be determined. In some embodiments, the categories are application and/or service types (FIGS. 4 and 5B). The first metadata and models of expected behavior (e.g., included in models 440 (FIG. 4) and/or table 500E (FIG. 5B)) can be used to determine application and/or service type(s) (e.g., categories) associated with the received network communications. By way of non-limiting example, when first metadata matches one or more of the data under the “Protocols/Common Ports,” “Target,” “Direction,” and “Application Payload/Message Semantics” columns in a row, the primary VM or container may be categorized with the “Service Type” for that row (FIG. 5B).

In addition or alternative to “Service Type,” other tags/labels (e.g., name) can be used to indicate application grouping. For example, an operator using tags/labels may introduce more granularity into the service definition (e.g., differentiating between internal- and external-facing Web servers), and customize default heuristics based upon their specific application architectures. In this way, categorization can be modifiable and extensible.

At step 630, the primary categorization may be evaluated for reliability and/or stability. In some embodiments, the primary categorization may be determined to be reliable and/or stable after a predetermined amount of time elapses. For example, enough network traffic associated with the primary VM (of VMs 260₁-260_{V} shown in FIG. 2) or container (of containers 340_{1,1}-340_{W,Z} shown in FIG. 4) has been received to reliably categorize the VM or container and/or the categorization does not substantially change (e.g., the categorization from packet to packet remains the same within a predetermined tolerance for deviation). By way of further non-limiting example, probabilistic methods such as Bayesian probabilistic thresholds, linear progression towards a model fit, and the like are used to determine reliability and/or stability of the primary (and other) categorization. When the primary categorization is determined to be reliable and/or stable, method 600 may continue to step 640. When the categorization is determined not to be reliable and/or stable, method 600 can return to step 610.

At step 640, a secondary categorization associated with at least one secondary VM (of VMs 260₁-260_{V} shown in FIG. 2) or container (of containers 340_{1,1}-340_{W,Z} shown in FIG. 4) may be determined. The secondary VM or container is a VM or container with which the primary VM or container communicates (e.g., as represented by the received network traffic). The first metadata and models of expected behavior (e.g., included in models 440 (FIG. 4) and/or table 500B (FIG. 5B)) can be used to determine application and/or service type(s) (e.g., categories) associated with the secondary VM or container. By way of non-limiting example, when first metadata matching one or more of the data under the “Protocols/Common Ports,” “Target,” “Direction,” and “Application Payload/Message Semantics” columns in a row may be categorized with the “Service Type” for that row (FIG. 5B).

At step 650, the primary and secondary categorizations can be evaluated for consistency. In some embodiments, the primary categorization, the secondary categorization, and models of expected behavior (e.g., included in models 440 (FIG. 4) and/or table 500B (FIG. 5B)) can be used to determine if the first and secondary categorizations are consistent. For example, when the “Service Type” associated with the secondary categorization matches (corresponds to) the “Target (allowed communication partners)” associated with the primary categorization, the primary and secondary categorizations may be determined to be consistent (e.g., agree with each other). By way of further non-limiting example, when the primary categorization is web server and the secondary categorization is file server, the primary and secondary categorizations may be determined to be consistent, because a web server communicating with a file server is an expected (network communications) behavior (e.g., as shown in FIG. 5B). When the primary and secondary categorizations are determined to be consistent, method 600 may continue to optional step 660. When the primary and secondary categorizations are determined not to be consistent, method 600 can return to step 610.

At optional step 660, tertiary metadata may be received. In some embodiments, tertiary metadata is metadata 430 received using API 420 (FIG. 4). Alternatively or additionally, at optional step 660 a type (e.g., tertiary categorization) can be determined from the received tertiary metadata. For example, an image type associated with a container in metadata 430 can be determined. According to some embodiments, an application/service running in the container is determined from the image type and the application/service running in the container is used as a tertiary categorization.

At optional step 670, the primary, secondary, and tertiary categorizations can be checked for agreement (e.g., consistency). In some embodiments, when the “Service Type” (FIG. 5B) associated with the primary categorization and secondary categorization matches the tertiary categorization (e.g., application/service running in the container), the primary, secondary, and tertiary categorizations may agree (e.g., be consistent with each other). For example, when the primary categorization and secondary categorization (e.g., determined from examination of network traffic) and the tertiary categorization (e.g., determined from metadata 430 (FIG. 4)) are all web server, the primary, secondary, and tertiary categorizations may be determined to be in agreement (consistent). By way of further non-limiting example, when the primary categorization and secondary categorization (e.g., determined from examination of network traffic) and the tertiary categorization (e.g., determined from metadata 430 (FIG. 4)) are all database, the primary, secondary, and tertiary categorizations may be determined to be in agreement (consistent). When the primary, secondary, and tertiary categorizations are determined to be in agreement (e.g., consistent), method 600 may continue to step 680. When the primary, secondary, and tertiary categorizations are determined not to be in agreement, method 600 can return to step 610.

At step 680, a model for a workload (or workload model; e.g., model 500C in FIG. 5C included in models 440 in FIG. 4) is produced for a workload (e.g., primary workload 510C). Alternatively or additionally, the workload model is checked for (sustained) convergence with expected behavior. For example, the protocol connections, categorization of secondary workloads, and optionally the metadata received from the container orchestration layer associated with the workload model are checked for conformity with the associated expected behavior(s). By way of further non-limiting example, probabilistic methods such as Bayesian probabilistic thresholds, linear progression towards a model fit, and the like are used to determine (sustained) convergence with expected behavior.

Optionally, at step 680 a security policy is generated using the workload model. For example, a high-level declarative security policy for the primary VM or container is produced using the workload model. In some embodiments, the workload model is used to determine expected (network communications) behaviors (e.g., the workload model is matched with one or more models of expected behavior associated with the workload model). A list of at least one of: allowed protocols, ports, and relationships for the database may be determined using the matched model(s) of expected behavior. By way of non-limiting example, when the workload model indicates the workload is a web server, an expected (network communications) behavior is outgoing communications with a file server (FIG. 5B).

A high-level security policy can comprise one or more high-level security statements, where there is one high-level security statement per allowed protocol, port, and/or relationship combination. The high-level declarative security policy can be at least one of: a statement of protocols and/or ports the primary VM or container is allowed to use, indicate applications/services that the primary VM or container is allowed to communicate with, and indicate a direction (e.g., incoming and/or outgoing) of permitted communications.

According to some embodiments, one application/service is subsequently used to identify several different machines associated with the single application/service. The high-level declarative security policy is at a high level of abstraction, in contrast with low-level firewall rules, which are at a low level of abstraction and only identify specific machines by IP address and/or hostname. Accordingly, one high-level declarative security statement can be compiled to produce hundreds or more of low-level firewall rules. The high-level security policy can be compiled by enforcement point 250 (or other machine) to produce a low-level firewall rule set. Compilation is described further in related United States patent application “Conditional Declarative Policies” (application Ser. No. 14/673,640) filed Mar. 30, 2015, which is hereby incorporated by reference for all purposes.

In some embodiments, method 600 is performed autonomously without intervention by an operator, other than operator input which may be received for model 440 (FIG. 4).

FIG. 7A illustrates a simplified block diagram of system 700, according to some embodiments. Additional and/or alternative elements of system 700 are shown in FIGS. 7B and 7C. System 700 may include security director 710, policy 720, analytics 730, log 740, management 750, orchestration layer 410, and enforcement points 250₁-250ᵤ.

Security director 710 can receive metadata from orchestration layer 410 (FIG. 4), for example, through at least one of enforcement points 250₁-250_{U}. For example, as described above in relation to FIG. 4, metadata from orchestration layer 410 can be reliable and authoritative metadata concerning containers, network topology, and the like (e.g., metadata 430 (FIG. 4). For example, when a container (e.g., of containers 340₁-340_{z} (FIG. 3) and 340_{1,1}-340_{W,Z} (FIG. 4)) is deployed, the container is assigned an (IP) address, which may be included in metadata received from orchestration layer 410.

Security director 710 can also be communicatively coupled to enforcement points 250₁-250_{U}. For example, security director 710 disseminates respective low-level security policies to enforcement points 250₁-250_{U}, each security policy applicable to a respective one of enforcement points 250₁-250_{U}. By way of further non-limiting example, security director 710 receives information logged by enforcement points 250₁-250_{U}, as described above in relation to FIG. 2 and stores it in log 740.

According to some embodiments, policy 720 is a data store of high-level declarative security policies and/or low-level firewall rule sets. A data store can be a repository for storing and managing collections of data such as databases, files, and the like, and can include a non-transitory storage medium (e.g., mass data storage 930, portable storage device 940, and the like described in relation to FIG. 9).

In various embodiments, analytics 730 provides computational analysis for data network security. For example, analytics 730 compiles high-level declarative security policies into low-level firewall rule sets. By way of further non-limiting example, analytics 730 analyzes log 740 for malicious behavior, and the like.

In accordance with some embodiments, log 740 is a data store of information logged by enforcement points 250₁-250_{U}, as described above in relation to FIG. 2. A data store can be a repository for storing and managing collections of data such as databases, files, and the like, and can include a non-transitory storage medium (e.g., mass data storage 930, portable storage device 940, and the like described in relation to FIG. 9).

Management 750 can dynamically commission (spawn/launch) and/or decommission instances of security director 610 and/or enforcement points 250₁-250_{U}. In this way, computing resources can be dynamically added to, reallocated in, and removed from an associated data network, and microsegmentation is maintained. For example, as containers (e.g., of containers 340₁-340_{z} (FIG. 3)) are added (and removed) instances of security director 710 and/or enforcement points 250₁-250_{U} are added (and removed) to provide security.

FIG. 7B depicts a simplified block diagram of system 700, in accordance with some embodiments. FIG. 7B illustrates additional and/or alternative elements of system 700 as shown in FIG. 7A. System 700 may include security director 710, attacker 760, critical application infrastructure 770, deception point 780, and at least one of enforcement point 250. In some embodiments, security director 710, critical application infrastructure 770, deception point 780, and at least one of enforcement point 250 are in one or more of data center 120 (FIG. 1). Security director was described above in relation to FIG. 7A. Enforcement point 250 was described above in relation to FIGS. 2, 4, and 7A.

Attacker 760 can be a computing system employed by one or more persons (unauthorized user or “hacker”) who seek and exploit weaknesses in data center 120. In some embodiments, attacker 760 is a computing system described below in relation to FIG. 9. By way of non-limiting example, attacker 760 attempts to discover information about an intended target computer system and/or computer network, identify potential ways of attack, and compromise the system and/or network by employing the vulnerabilities found through the vulnerability analysis. By way of further non-limiting example, attacker 760 can disrupt the operation of and/or make unauthorized copies of sensitive information in critical application infrastructure 770, through unauthorized access of data center 120. Although depicted outside of data center 120, attacker 760 can be, for example, a computing system inside data center 120 that was compromised by and under the control an unauthorized user.

Critical application infrastructure 770 can be one or more workloads in one or more data centers that provide important/essential services. By way of non-limiting example, critical application infrastructure 770 comprises combinations and permutations of physical hosts (e.g., physical hosts 160_{1,1}-160_{x,y} shown in FIG. 1; also referred to as “bare metal” servers), VMs (e.g., VMs 260₁-260_{V} shown in FIG. 2), containers (e.g., containers 340₁-340_{Z} shown in FIG. 3), and the like.

By way of further non-limiting example, critical application infrastructure 770 comprises various combinations and permutations of name servers, time servers, authentication servers, database servers, file servers, and the like. Some of the servers of critical application infrastructure 770 can be bastion hosts. A bastion host is a special purpose computer on a network specifically designed and configured to withstand attacks. The bastion host can hosts a single application, for example a proxy server, and all other services are removed or limited to reduce the threat to the computer. Name servers (e.g., Domain Name System (DNS) server, a server running Active Directory Domain Services (AD DS) called a domain controller, etc.) can implement a network service for providing responses to queries against a directory service. Time servers (e.g., Network Time Protocol (NTP) server) can read an actual time from a reference clock and distribute this information to client computers using a computer network. Authentication servers (e.g., Kerberos server, Terminal Access Controller Access-Control System (TACACS) server, Remote Authentication Dial-In User Service (RADIUS) server) provide a network service that applications use to authenticate the credentials, usually account names and passwords, of their users. Database servers provide database services to other computer programs or computers (e.g., database servers can run Microsoft® SQL Server®, MongoDB, HTFS, MySQL®, Oracle® database, etc.). File servers store, manage, and control access to separate files (e.g., file servers can run Linux server, Microsoft® Windows Server®, Network File System (NFS), HTTP File Server (HFS), Apache® Hadoop®, etc.).

As described in relation to FIG. 4, enforcement point 250 can use a low-level firewall rule set to detect (possible) violations of a high-level security policy. When a (possible) violation is detected, enforcement point 250 can forward the (suspect) communication (e.g., data packet(s)) to deception point 780. In some embodiments, the (potentially) malicious communication can be forwarded from enforcement point 250 to deception point using encapsulation (also known as tunneling, such as Cisco® Virtual Extensible LAN (VXLAN), Cisco® Generic Routing Encapsulation (GRE), etc.). For example, enforcement point 250 embeds/encapsulates packets to be forwarded (e.g., having a destination address and/or port of critical infrastructure 770) inside another packet (e.g., having a destination address and/or port of deception point 780). Encapsulation can offer the benefit of preserving the original packet to be forwarded.

Deception point 780 can comprise one or more physical hosts (e.g., physical hosts 160_{1,1}-160_{x,y} shown in FIG. 1; also referred to as “bare metal” servers), VMs (e.g., VMs 260₁-260_{V} shown in FIG. 2), containers (e.g., containers 340₁-340_{Z} shown in FIG. 3), and the like. Deception point 780 can emulate/imitate one or more workloads/servers of critical application infrastructure 770, such as a name server, time server, authentication server, and the like. While seeming to provide at least some of the actual service, resources, data, etc. of critical application infrastructure 770 to attacker 760, deception point 780 is really a (isolated) decoy such that actual services, resources, data, etc. are not placed at risk. Deception point 780 provides observation/logging of actions taken by attacker 760 accessing deception point 780, as if deception point 780 were some part of critical application infrastructure 770. In some embodiments, deception point 780 communicates with attacker 760 in such a way that the communications appear to originate from critical application infrastructure 770, such as using Network Address Translation (NAT). For example, deception point 780 remaps one IP address space into another by modifying network address information in Internet Protocol (IP) datagram packet headers.

The emulation/imitation can be rudimentary to sophisticated. By way of non-limiting example, deception point 780 can provide a simple login window (e.g., username and password prompt) to learn what credential attacker 760 uses. By way of further non-limiting example, deception point 780 includes a fake hostname and emulates the shell of a Linux® server to observe methodologies employed by attacker 760. Deception point 780 can allow attacker 760 to load (and install) a file on deception point 780, and the file can subsequently be analyzed for malware.

In some embodiments, deception point 780 provides multiple emulations/imitations using one identification (e.g., hostname, IP address, etc.). In various embodiments, deception point 780 provides certain emulations/imitations using a particular identification (e.g., hostname, IP address, etc.) associated with the one or more emulations/imitations. By way of non-limiting example, a command-line login for SSH and a basic Apache® HTTP Server™ for HTTP can be provided using one identification or separate identifications (e.g., hostname, IP address, etc.). Accordingly, the high-level security policy can specify one identification (e.g., hostname, IP address, etc.) for all prohibited behaviors or multiple identifications for one or more particular prohibited behaviors. In various embodiments, deception point 780 is a dynamic honeypot.

FIG. 7C depicts a simplified block diagram of system 700, in accordance with various embodiments. FIG. 7C illustrates additional and/or alternative elements of system 700 as shown in FIGS. 7A and 7B. System 700 may include critical application infrastructure 770, deception point 780, at least one of enforcement point 250, trusted administrator 790, and jump server 795. In some embodiments, critical application infrastructure 770, deception point 780, at least one of enforcement point 250, trusted administrator 790, and jump server 795 are in one or more of data center 120 (FIG. 1). Critical application infrastructure 770 and deception point 780 were described above in relation to FIG. 7B. Enforcement point 250 was described above in relation to FIGS. 2, 4, 7A, and 7B.

Trusted administrator 790 (also called a management host) is a computer (e.g., computing system described below in relation to FIG. 9, virtual machine, container, and the like) operated by authorized system administrators who are responsible for the upkeep, configuration, and reliable operation of critical application infrastructure 770. The legitimate activities of authorized system administrators using trusted administrator 790 can violate the low-level firewall rule set (e.g., derived from a high-level security policy), because the legitimate system administration activities deviate from expected behavior and/or are similar to prohibited behaviors that attacker 760 (FIG. 7B) could use. Accordingly, communications from trusted administrator 790 could be forwarded by enforcement point 250 to deception point 780 instead of critical application infrastructure 770.

In some embodiments, a whitelist of hosts including trusted administrator 790 can be used with a high-level security policy to allow communications between trusted administrator 790 and critical application infrastructure 770. For example, there can be an exception high-level rule to allow (forward) packets from systems in the whitelist of trusted hosts (e.g., trusted administrator 790) to critical application infrastructure 770. In this way, communications between trusted administrator 790 and critical application infrastructure 770 would not violate the high-level security policy (e.g., would not be included with the prohibited behaviors) and would be permitted.

In various embodiments, system 700 includes jump server 795 (also known as a jump host or jumpbox). Jump server 795 can be a (special-purpose) computer (e.g., computing system described below in relation to FIG. 9, virtual machine, container, and the like) on a network for managing devices in a separate security zone. Jump server 795 can be included in the whitelist of trusted computers such that communication using jump server 795 would not violate the high-level security policy (e.g., would not be included with the prohibited behaviors) and would be permitted. For example, communications from trusted administrator 790 to critical application infrastructure 770 goes from trusted administrator 790 to (one of) enforcement point 250 to jump server 795 to (one or another of) enforcement point 250 to critical application infrastructure 770.

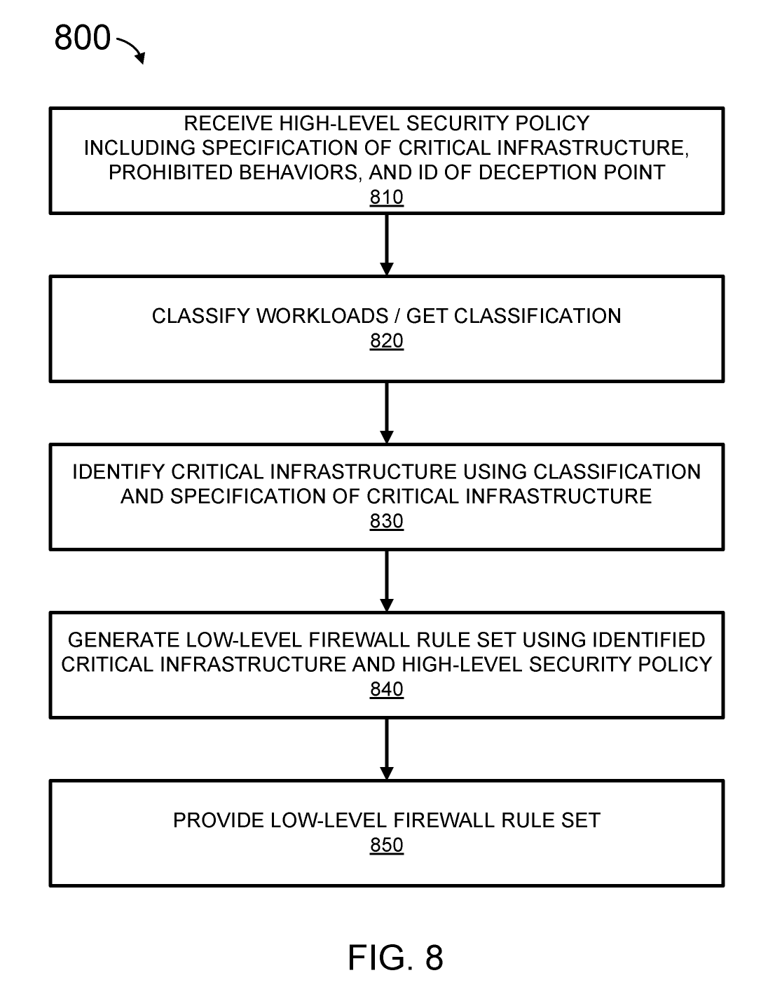

FIG. 8 is a simplified flow diagram for a method for directing data traffic from an unauthorized user (e.g., attacker 760 in FIG. 7B) to a security mechanism (e.g., deception point 780). At step 810 a high-level security policy is received. In some embodiments, the high-level security policy includes a specification of critical application infrastructure, prohibited behaviors, and optionally identification(s) associated with the security mechanism (e.g., IP address, hostname, etc.). For example, server types and/or service types (e.g., certain types of name servers, time servers, authentication servers, etc.) are specified as comprising critical application infrastructure 770 (such that a workload being/providing the specified server type/service type would be identified as part of the critical application infrastructure). By way of further example, prohibited behaviors are protocols/services not commonly used by the specified critical application infrastructure (but used by unauthorized users). A prohibited behavior can be a deviation from expected behaviors. For example, name servers, time servers, authentication servers, etc. do not generally use protocols/services such as Hypertext Transfer Protocol (HTTP), Secure Shell (SSH), telnet, Remote Desktop Protocol (RDP), and the like (but unauthorized users do).

In various embodiments, certain ones of prohibited behaviors are associated with a particular security mechanism (e.g., deception point 780). For example, when the prohibited behavior is HTTP, an associated deception point includes a basic Apache® HTTP Server. By way of further example, when the prohibited behavior is SSH, an associated deception point includes a command-line login. These two example security mechanisms may be provided using one identification (e.g., hostname, IP address, etc.) or separate identifications.

At step 820, workloads in a network can be classified or a classification of workloads can be received. By way of non-limiting example, all data traffic to and from workloads in a network is logged by one or more enforcement points 250. Security director 710 can analyze the logs and identify a classification for each workload, for example, using the primary categorization, the secondary categorization, and optionally the tertiary categorization. By way of further non-limiting example, workloads in a network can be classified using at least some of the steps of method 600 in FIG. 6.

At step 830, workloads comprising critical application infrastructure can be identified using the classification and the specification of the critical application infrastructure. In some embodiments, workloads having a classification associated with or corresponding to the critical application infrastructure specification are identified as a part of the critical application infrastructure. By way of non-limiting example, if DNS servers are included in the critical application infrastructure specification and a workload is classified as a DNS server, then the workload is identified as being included in the critical application infrastructure.

At step 840, a low-level firewall rule set is generated. In some embodiments, a high-level security policy is used to generate the low-level firewall rule set. For example, the high-level security policy includes: any network traffic to the identified critical application infrastructure using any of the specified prohibited behaviors is directed (not to critical application infrastructure but instead) to a security mechanism (e.g., deception point 780) or dropped. The high-level security policy can be compiled to produce a low-level firewall rule set. In some embodiments, depending on the network topology, the high-level security policy can be compiled into a respective low-level firewall rule set for each enforcement point (e.g., enforcement point 250 in FIG. 7B), (hardware and/or software firewall), switch, router, and the like. High-level policies, compilation of high-level policies, and low-level firewall rule sets were described above in relation to FIGS. 2-6.

At step 850, the low-level firewall rule is provided to at least one of an enforcement point (e.g., enforcement point 250 in FIG. 7B), (hardware and/or software firewall), switch, router, etc. As noted above, each of the at least one enforcement point (e.g., enforcement point 250 in FIG. 7B), (hardware and/or software firewall), (hardware and/or virtual) switch, router, etc. can receive a respective low-level firewall rule set, according to the network topology.

In some embodiments, attack traffic (e.g., network traffic including prohibited behavior directed at the critical application infrastructure) is forwarded (e.g., using tunneling/encapsulation as described in relation to FIG. 7B) to the security mechanism (e.g., deception point 780). In various embodiments, the at least one enforcement point, (hardware and/or software firewall), (hardware and/or virtual) switch, router, etc. drops the attack traffic.

Embodiments of the present invention include the benefits of autonomously classifying workloads, thereby identifying critical application infrastructure (e.g., critical application infrastructure 770 in FIG. 7B), producing and providing a low-level firewall rule set at all communication entry points to the critical application infrastructure, and routing unauthorized access to a security mechanism (e.g., deception point 780) to protect the critical application infrastructure and analyze the unauthorized access. Except where an operator may initially adjust the specification of the critical application infrastructure (e.g., for a particular data center or to whitelist systems which have (full) access to the critical application infrastructure), user intervention is not required.

FIG. 9 illustrates an exemplary computer system 900 that may be used to implement some embodiments of the present invention. The computer system 900 in FIG. 9 may be implemented in the contexts of the likes of computing systems, networks, servers, or combinations thereof. The computer system 900 in FIG. 9 includes one or more processor unit(s) 910 and main memory 920. Main memory 920 stores, in part, instructions and data for execution by processor unit(s) 910. Main memory 920 stores the executable code when in operation, in this example. The computer system 900 in FIG. 9 further includes a mass data storage 930, portable storage device 940, output devices 950, user input devices 960, a graphics display system 970, and peripheral device(s) 980.

The components shown in FIG. 9 are depicted as being connected via a single bus 990. The components may be connected through one or more data transport means. Processor unit(s) 910 and main memory 920 are connected via a local microprocessor bus, and the mass data storage 930, peripheral device(s) 980, portable storage device 940, and graphics display system 970 are connected via one or more input/output (I/O) buses.

Mass data storage 930, which can be implemented with a magnetic disk drive, solid state drive, or an optical disk drive, is a non-volatile storage device for storing data and instructions for use by processor unit(s) 910. Mass data storage 930 stores the system software for implementing embodiments of the present disclosure for purposes of loading that software into main memory 920.

Portable storage device 940 operates in conjunction with a portable non-volatile storage medium, such as a flash drive, floppy disk, compact disk, digital video disc, or Universal Serial Bus (USB) storage device, to input and output data and code to and from the computer system 900 in FIG. 9. The system software for implementing embodiments of the present disclosure is stored on such a portable medium and input to the computer system 900 via the portable storage device 940.

User input devices 960 can provide a portion of a user interface. User input devices 760 may include one or more microphones, an alphanumeric keypad, such as a keyboard, for inputting alphanumeric and other information, or a pointing device, such as a mouse, a trackball, stylus, or cursor direction keys. User input devices 960 can also include a touchscreen. Additionally, the computer system 900 as shown in FIG. 9 includes output devices 950. Suitable output devices 950 include speakers, printers, network interfaces, and monitors.

Graphics display system 970 include a liquid crystal display (LCD) or other suitable display device. Graphics display system 970 is configurable to receive textual and graphical information and processes the information for output to the display device.

Peripheral device(s) 980 may include any type of computer support device to add additional functionality to the computer system.

The components provided in the computer system 900 in FIG. 9 are those typically found in computer systems that may be suitable for use with embodiments of the present disclosure and are intended to represent a broad category of such computer components that are well known in the art. Thus, the computer system 900 in FIG. 9 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 900 may be implemented as a cloud-based computing environment, such as a virtual machine operating within a computing cloud. In other embodiments, the computing system 900 may itself include a cloud-based computing environment, where the functionalities of the computing system 900 are executed in a distributed fashion. Thus, the computing system 900, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computing system 600, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical, magnetic, and solid-state disks, such as a fixed disk. Volatile media include dynamic memory, such as system random-access memory (RAM). Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a programmable read-only memory (PROM), an erasable programmable read-only memory (EPROM), an electrically erasable programmable read-only memory (EEPROM), a Flash memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

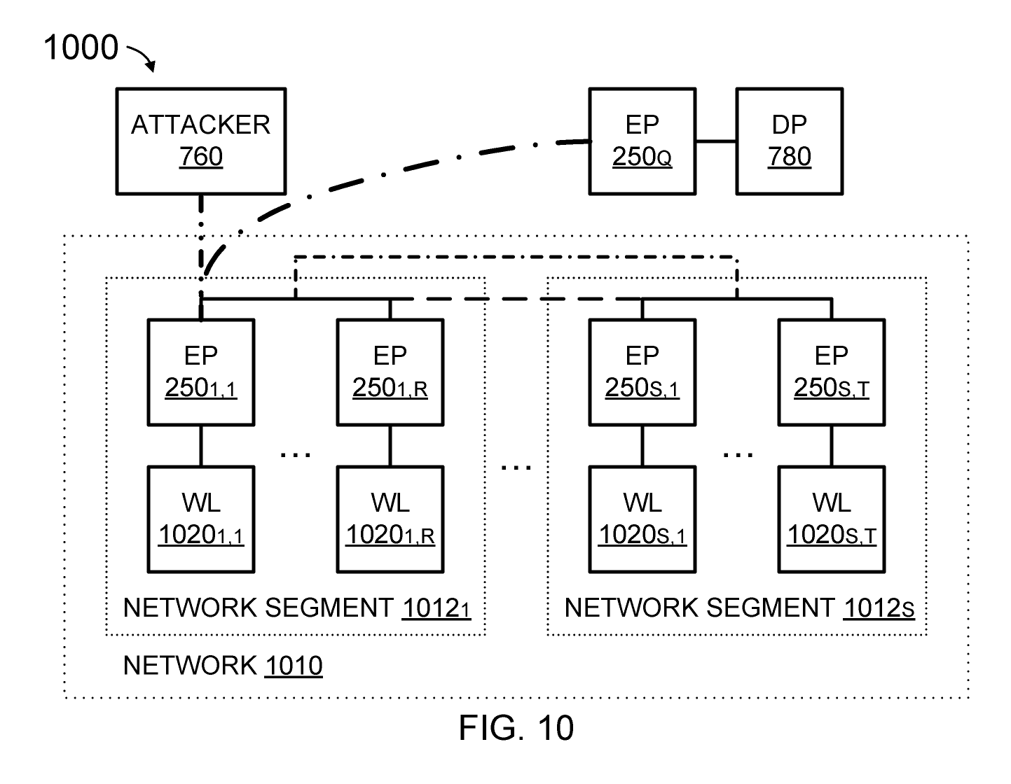

FIG. 10 depicts a simplified block diagram of system 1000, in accordance with some embodiments. FIG. 10 illustrates additional and/or alternative elements of system 700 as shown in FIGS. 7A-7C. System 1000 may include enforcement points 250_{1,1}-250_{S,T} and 250_{Q}, attacker 760, deception point 780, and workloads 1020_{1,1}-1020_{S,T}. In various embodiments, enforcement points 250_{1,1}-250_{S,T} and workloads 1020_{1,1}-1020_{S,T} are in network 1010. For example, network 1010 comprises critical application infrastructure 770 described above in relation to FIGS. 7B and 7C. By way of further non-limiting example, network 1010 comprises network segments 1012₁-1012_{S}. Network segment 1012₁ can include enforcement points 250_{1,1}-250_{1,R} and workloads 1020_{1,1}-1020_{1,R}. Network segment 1012_{S} can include enforcement points 250_{S,1}-250_{S,T} and workloads 1020_{S,1}-1020_{S,T}.

Network 1010 can comprise logically and/or physically segmented networks. For example, combinations of network segments 1012₁-1012_{S} can be the same (or different) local area network(s) (LANs) and can be included in the same geographic or physical systems. As described below, combinations of network segments 1012₁-1012_{S} can be logically segmented internally and between each other using enforcement points 250_{1,1}-250_{S,T}. Additionally or alternatively, combinations of network segments 1012₁-1012_{S} can be different local area networks (LANs), can be included in different geographic or physical systems, and can be physically separated by hardware firewalls, routers, and the like.

Workloads 1020_{1,1}-1020_{S,T} can be combinations and permutations of physical hosts (e.g., physical hosts 160_{1,1}-160_{x,y} shown in FIG. 1; also referred to as “bare metal” servers), VMs (e.g., VMs 260₁-260_{V} shown in FIG. 2), containers (e.g., containers 340₁-340_{Z} shown in FIG. 3), microservices, and the like. A microservice is an element of functionality of an application. Microservices are independently deployable (e.g., in various combinations of bare metal servers, virtual machines, and containers) and scalable. In contrast to a monolithic application having all of its functionality in one process, an application having a microservices architecture puts each element of functionality into a separate microservice. When a monolithic application is scaled, the whole monolithic application is replicated for each instance. An application having a microservices architecture can scale by distributing various combinations and permutations of its microservices across the same or different physical host, VMs, containers, and the like for each instance. At least some of workloads 1020_{1,1}-1020_{S,T} can be included in the critical application infrastructure (e.g., critical application infrastructure 770 in FIGS. 7B and 7C).

Enforcement points 250_{1,1}-250_{S,T} and 250_{Q} were described above in relation to enforcement point in 250₁-250_{V}, 250, 250₁-250_{U}, 250, and 250 in FIGS. 2, 4, and 7A-7C, respectively. For example, enforcement points 250_{1,1}-250_{S,T} apply respective low-level security rule sets to control communications among workloads 1020_{1,1}-1020_{S,T}, segmenting network 1010 (e.g., into network segments 1012₁-1012_{S}). In a segmented network, entities in the data network (e.g., physical servers, VMs, containers, etc.) can be grouped into segments, such that communications among entities within a group (segment) are permitted and optionally limited by such characteristics as source/destination address, source/destination ports, protocols used, applications used, the like, and combinations thereof. Communications among entities in different groups (segments) can be restricted, for example, not permitted at all and/or limited by a more restrictive set of characteristics than are generally permitted within a particular group.

As described in relation to enforcement point 250 in FIGS. 4 and 7B, enforcement points 250_{1,1}-250_{S,T} and 250_{Q} can use a low-level security rule set to detect (possible) violations of a high-level security policy (e.g., actions taken by attacker 760). For example, each of enforcement points 250_{1,1}-250_{S,T} includes a respective low-level security rule set which was generated using at least a common high-level declarative security policy. High-level policies, compilation of high-level policies, and low-level security rule sets were described above in relation to FIGS. 2-6 and 8. Low-level security rule sets which have at least some of the characteristics of low-level firewall rule sets were described in relation to FIGS. 2-6 and 8.

For example, the common high-level declarative policy can include a high-level security statement that communications (e.g., data packets) addressed to unused addresses (e.g., IP addresses not assigned to any of workloads 1020_{1,1}-1020_{S,T}) are forwarded to deception point 780. Additionally or alternatively, the common high-level declarative policy can include a high-level security statement that communications directed to a valid address (e.g., IP address assigned to a particular one of workloads 1020_{1,1}-1020_{S,T}) but also to an unused port (e.g., port is not used by the particular one of workloads 1020_{1,1}-1020_{S,T}) are forwarded to deception point 780. Additionally or alternatively, the common high-level declarative policy can include a high-level security statement that communications directed to particular workloads (e.g., critical application infrastructure 770 in FIGS. 7B and 7C)—which may only be managed using a (particular) jump server (e.g., jump server 795 in FIG. 7C)—that do not come from the (particular) jump server are forwarded to deception point 780. The above examples are only for illustrative purposes and are not intended to be limiting. Other common high-level declarative policies having different high-level security statements may also be used. For example, other high-level security statements distinguish data communications (e.g., data packets) from each other using (one or more) characteristics of a Transmission Control Protocol/Internet Protocol (TCP/IP) connection, such as a source address (e.g., IP address), source port number, destination address (e.g., IP address), destination port, and protocol in use. These TCP/IP connection characteristics can be referred to as a 5-tuple. When a (possible) violation is detected (e.g., using a low-level security rule set derived from the common high-level declarative policy), enforcement points 250_{1,1}-250_{S,T} can forward the (suspect) communication (e.g., data packet(s)) to deception point 780 (e.g., for observation).

In various embodiments, while at a lower level of abstraction than a high-level security policy (as explained above), each rule of the low-level security rule set can include (e.g., inherit) at least some characteristics from the high-level security policy used to generate the low-level security rule set. By way of non-limiting example, a low-level security rule can include at least one characteristic of a TCP/IP connection, such as a source address (e.g., IP address), source port number, destination address (e.g., IP address), destination port, and protocol in use, which can be referred to as a 5-tuple.

In some embodiments, the (potentially) malicious communication can be forwarded from an enforcement point (e.g., one of enforcement points 250_{1,1}-250_{S,T}) to deception point 780 using encapsulation (also known as tunneling, such as Cisco® Virtual Extensible LAN (VXLAN), Cisco® Generic Routing Encapsulation (GRE), etc.). For example, enforcement point 250 embeds/encapsulates packets to be forwarded (e.g., having a destination address and/or port of workload 1020_{1,1} in critical infrastructure 770 in FIGS. 7B and 7C) inside another packet (e.g., having a destination address and/or port of deception point 780). Encapsulation can offer the benefit of preserving the original packet to be forwarded.

Attacker 760 was described above in relation to FIG. 7B. Although attacker 760 is shown outside of network 1010 in FIG. 10, in some embodiments, attacker 760 is inside network 1010. As shown in the non-limiting example of FIG. 10, attacker 760 can send a malicious data packet to workload 1020_{1,1} (e.g., to compromise the security of network 1010). Enforcement point 250_{1,1} receives the malicious data packet and determines a low-level firewall rule applies to the malicious data packet. The low-level firewall rule indicates the malicious data packet should be sent to deception point 780. Enforcement point 250_{1,1} forwards the malicious data packet to deception point 780. Additionally or alternatively, attacker 760 can send a malicious data packet to another of workloads 1020_{1,1}-1020_{S,T} and a respective enforcement point of enforcement points 250_{1,1}-250_{S,T} can similarly act on the packet as described above.

Deception point 780 has at least some of the characteristics of deception point 780 described above in relation to FIGS. 7B and 7C. For example, deception point 780 can monitor and record interactions with attacker 760 (e.g., communications between deception point 780 and attacker 760, such as packet source address, packet source port, packet destination address, packet destination port, protocol, and the like). Additionally or alternatively, in various embodiments, deception point 780 can monitor and record: creation, modification, and removal of network connections, processes, files, and folders; memory usage changes; disk usage changes; network connection bonding of processes (e.g., which processes are listening to a socket or port, which processes initiate network a network connection, and the like); credentials used to get past authentication; and inbound and outbound network connections. A log of the monitored and recorded information can be used to determine if the communications is malicious and analyze the mode of attack to prepare countermeasures. For example, deception point 780 can initiate analysis by security director 710 (FIGS. 7A and 7B).

Hardware firewalls (e.g., firewall 130 in FIG. 1) are usually deployed to connect to a wide area network (e.g., network 110 in FIG. 1) such as the Internet and usually cannot protect against the lateral spread of malware inside a data center (e.g., data center 120), which is called east-west movement. In contrast, enforcement points 250_{1,1}-250_{S,T} are dispersed with workloads 1020_{1,1}-1020_{1,R} inside network 1010. Using enforcement points 250_{1,1}-250_{S,T} and respective low-level security rule sets—which were generated using at least a common high-level declarative security policy including a high-level security statement as described above—actions to compromise network 1010 by attacker 760 can be prevented and studied.

Some deception points generally serve a particular network segment. Since enforcement points 250_{1,1}-250_{S,T} can each forward communications from their respective different logical and/or physical network segments, deception point 780 can advantageously protect multiple different logical and/or physical network segments.

In addition, deception point 780 and enforcement point 250_{Q} can be outside of network 1010, to protect network 1010 by moving communications with attacker 760 outside of network 1010. Were deception point 780 to be (hypothetically) compromised by attacker 760, enforcement point 250_{Q} can block communications into network 1010 (e.g., communications from deception point 780 may go out to attacker 760 and not to network 1010).

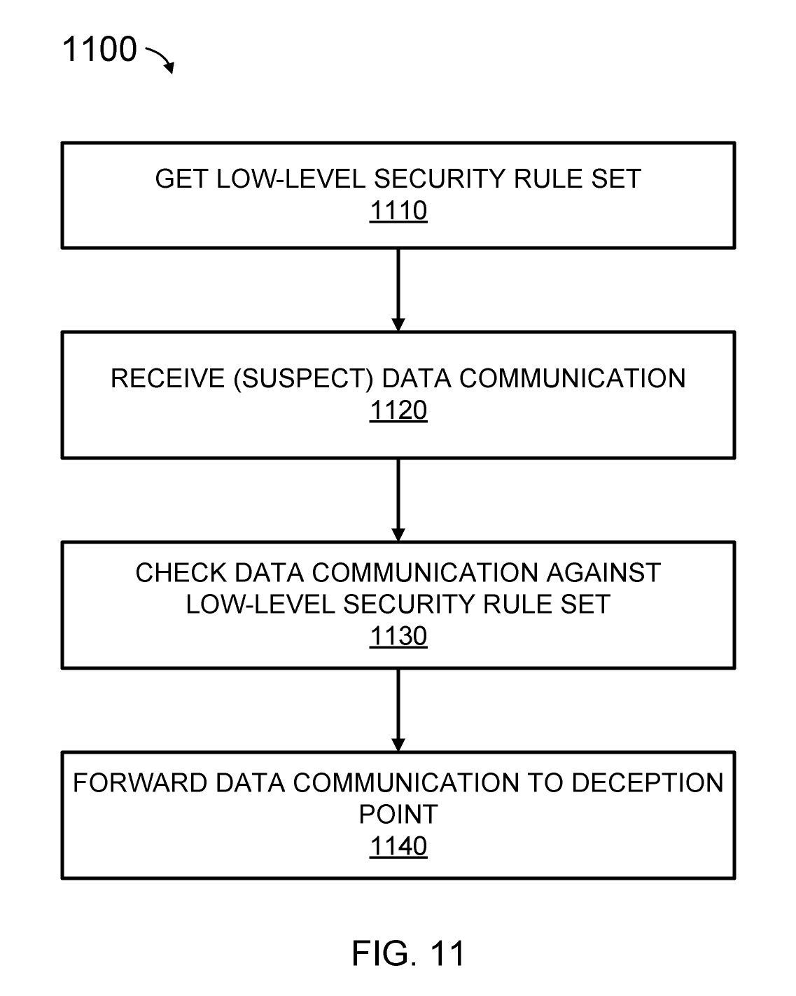

FIG. 11 is a simplified flow diagram for a method 1100 for directing (potentially) malicious communications (e.g., from attacker 760) to a deception point (e.g., deception point 780; e.g., for analysis). In some embodiments, method 1100 is performed additionally and/or alternatively to some of the steps of method 600 (FIG. 6) and/or method 800 (FIG. 8). In various embodiments, method 1100 is performed by enforcement points 250_{1,1}-250_{S,T} (FIG. 10).

At step 1110, a low-level security rule set is received. For example, the low-level security rule set is received from security director 710 (FIGS. 7A and 7B). By way of further non-limiting example, the low-level security rule set can be produced using at least a common high-level declarative security policy including a high-level security statement, as described above in relation to FIG. 10.

At step 1120, a (potentially-malicious) data communication is received. For example, a data packet can be received from attacker 760 (FIG. 10). By way of further non-limiting example, the data packet can have a destination address of one of workloads 1020_{1,1}-1020_{S,T}.

At step 1130, a low-level security rule set is applied to the received data communications. For example, characteristics of the received data communications are checked to see if (any of) the low-level firewall rules are applicable. By way of further non-limiting example, the characteristics include a 5-tuple of the received data communications.

At step 1140, the received data communications is forwarded to a deception point (e.g., deception point 780). For example, when a low-level firewall rule is applicable, the action (e.g., forward to indicated destination, forward to deception point, drop, and the like) indicated by the firewall rule is taken. By way of further non-limiting example, the received data communications is forwarded using encapsulation. As described above, deception point 780 can monitor and record interactions between attacker 760 and deception point 780, and produce a log.

In some embodiments, security director 710 (FIGS. 7A and 7B) receives a log of interactions between attacker 760 and deception point 780 (e.g., from deception point 780). In various embodiments, deception point 780 launches analysis by security director 710. Security director 710 can analyze the log, determine the data communications are malicious (or not), and identify a mode of attack. When it is determined attacker 760 is attempting to breach network security, security director 710 can produce a high-level declarative security policy to prevent/stop the mode of attack, (launch a compiler to) produce a (respective) low-level security rule set (for each of enforcement points 250_{1,1}-250_{S,T}), and supply the (respective) low-level security rule set (to each of enforcement points 250_{1,1}-250_{S,T}).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

What is claimed is:

1. A computer-implemented method for diversifying coverage of a deception point comprising:
receiving, by a first enforcement point in a first data network segment, a first data packet addressed to a first workload in the first data network segment;
forwarding the first data packet to the deception point using a first low-level security rule set, the deception point being different from the first workload, the deception point logging the first data packet to produce a first log, the first low-level security rule set being produced using a high-level declarative security policy, the high-level declarative security policy including a high-level security statement;
receiving, by a second enforcement point in a second data network segment, a second data packet addressed to a second workload in the second data network segment, the first data network segment and the second data network segment being in a common network; and
forwarding the second data packet to the deception point using a second low-level security rule set, the deception point being different from the second workload, the deception point logging the second data packet to produce a second log, the deception point providing the first and second logs to a security director for analysis, the second low-level security rule set being produced using the high-level declarative security policy including the high-level security statement.

2. The computer-implemented method of claim 1, wherein the high-level security statement directs data packets being addressed to unassigned addresses to the deception point.

3. The computer-implemented method of claim 1, wherein the high-level security statement directs data packets being addressed to an assigned address and directed to an inactive port at the address to the deception point.

4. The computer-implemented method of claim 1, wherein the high-level security statement directs data packets being addressed to an assigned addresses, directed to an active management port, and originating from a non-jump server to the deception point.

5. The computer-implemented method of claim 1, wherein the first data packet is forwarded using a first tunnel and the second data packet is forwarded using a second tunnel.

6. The computer-implemented method of claim 1, wherein:
the forwarding the first data packet to the deception point using the first low-level security policy is based on at least one of a source Internet Protocol (IP) address, source port, destination IP address, and destination port of the first data packet, and
the forwarding the second data packet to the deception point using the second low-level security policy is based on at least one of a source IP address, source port, destination IP address, and destination port included of the second data packet.

7. The computer-implemented method of claim 1, wherein:
the deception point and a third enforcement point associated with the deception point are outside of the common network, and
the third enforcement point drops data packets from the deception point and addressed to workloads in the common network.

8. The computer-implemented method of claim 1, wherein the first data network segment comprises a first plurality of workloads, the second data network segment comprises a second plurality of workloads, each of the first plurality of workloads and the second plurality of workloads being one of a bare-metal server, virtual machine, container, and microservice.

9. The computer-implemented method of claim 8, wherein the first data network segment and the second data network segment are physically separated from each other by at least one of a hardware firewall and a hardware router.

10. The computer-implemented method of claim 8, wherein the first data network segment and the second data network segment are logically separated from each other by a first plurality of enforcement points and a second plurality of enforcement points, the first plurality of enforcement points being in the first data network segment, the second plurality of enforcement points being in the second data network segment, the first plurality of enforcement points forwarding data packets among workloads in the first data network segment and dropping data packets to the second data network, the first plurality of enforcement points forwarding data packets among workloads in the second data network segment and dropping data packets to the first data network.

11. A system for diversifying coverage of a deception point comprising:
at least one hardware processor; and
a memory coupled to the at least one hardware processor, the memory storing instructions which are executable by the at least one hardware processor to perform a method comprising:
receiving, by a first enforcement point in a first data network segment, a first data packet addressed to a first workload in the first data network segment;
forwarding the first data packet to the deception point using a first low-level security rule set, the deception point being different from the first workload, the deception point logging the first data packet to produce a first log, the first low-level security rule set being produced using a high-level declarative security policy, the high-level declarative security policy including a high-level security statement;
receiving, by a second enforcement point in a second data network segment, a second data packet addressed to a second workload in the second data network segment, the first data network segment and the second data network segment being in a common network; and
forwarding the second data packet to the deception point using a second low-level security rule set, the deception point being different from the second workload, the deception point logging the second data packet to produce a second log, the deception point providing the first and second logs to a security director for analysis, the second low-level security rule set being produced using the high-level declarative security policy including the high-level security statement.

12. The system of claim 11, wherein the high-level security statement directs data packets being addressed to unassigned addresses to the deception point.

13. The system of claim 11, wherein the high-level security statement directs data packets being addressed to an assigned address and directed to an inactive port at the address to the deception point.

14. The system of claim 11, wherein the high-level security statement directs data packets being addressed to an assigned addresses, directed to an active management port, and originating from a non-jump server to the deception point.

15. The system of claim 11, wherein the first data packet is forwarded using a first tunnel and the second data packet is forwarded using a second tunnel.

16. The system of claim 11, wherein:
the forwarding the first data packet to the deception point using the first low-level security policy is based on at least one of a source Internet Protocol (IP) address, source port, destination IP address, and destination port of the first data packet, and
the forwarding the second data packet to the deception point using the second low-level security policy is based on at least one of a source IP address, source port, destination IP address, and destination port included of the second data packet.

17. The system of claim 16, wherein:
the deception point and a third enforcement point associated with the deception point are outside of the common network, and
the third enforcement point drops data packets from the deception point and addressed to workloads in the common network.

18. The system of claim 11, wherein the first data network segment comprises a first plurality of workloads, the second data network segment comprises a second plurality of workloads, each of the first plurality of workloads and the second plurality of workloads being one of a bare-metal server, virtual machine, container, and microservice.

19. The system of claim 18, wherein the first data network segment and the second data network segment are physically separated from each other by at least one of a hardware firewall and a hardware router.

20. A system for diversifying coverage of a deception point comprising:
means for receiving a first data packet addressed to a first workload in a first data network segment;
means for forwarding the first data packet to the deception point using a first low-level security rule set, the deception point being different from the first workload, the deception point logging the first data packet to produce a first log, the first low-level security rule set being produced using a high-level declarative security policy, the high-level declarative security policy including a high-level security statement;
means for receiving a second data packet addressed to a second workload in a second data network segment, the first data network segment and the second data network segment being in a common network; and
means for forwarding the second data packet to the deception point using a second low-level security rule set, the deception point being different from the second workload, the deception point logging the second data packet to produce a second log, the deception point providing the first and second logs to a security director for analysis, the second low-level security rule set being produced using the high-level declarative security policy including the high-level security statement.
